(19) United States
(12) Patent Application Publication
(10) Pub. No.: US 2004/0254851 A1
(43) Pub. Date: Dec. 16, 2004

(54) Electronic merchandise distribution apparatus, electronic merchandise receiving terminal, and electronic merchandise distribution method

(75) Inventors: Yoshitada Himeno, Fukaya-shi (JP); Hideaki Kitafusa, Tokyo (JP); Hisanori Fujita, Ome-shi (JP); Arata Ando, Nishitokyo-shi (JP); Nobuhiko Yuasa, Hamura-shi (JP); Akihiro Nonoyama, Komae-shi (JP); Yoshihisa Kizuka, Ome-shi (JP); Kazuyoshi Ozawa, Yokohama-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/805,361

(22) Filed: Mar. 22, 2004

(30) Foreign Application Priority Data
Jun. 16, 2003 (JP) 2003-171334

(51) Int. Cl. G06F 7/00

(52) U.S. Cl. 705/26

(57) ABSTRACT

An electronic merchandise distribution apparatus includes an information management unit which acquires at least one of viewing information, preference information, and retrieval information of a user who uses one of a plurality of terminals, and a distribution management unit which stores non-real-time contents compressed by a CODEC, in an access provider corresponding to one of the plurality of terminals used by the user, based on the acquired at least one of the viewing information, preference information, and retrieval information of the user, prior to receiving the contents viewing request from the user.

### CROSS-REFERENCE TO RELATED APPLICATIONS

This application is based upon and claims the benefit of priority from prior Japanese Patent Application No. 2003-171334, filed Jun. 16, 2003, the entire contents of which are incorporated herein by reference.

### BACKGROUND OF THE INVENTION

1. Field of the Invention

The present invention relates to an electronic merchandise distribution apparatus and an electronic merchandise distribution method for providing contents such as movies distributed as electronic merchandise to viewers.

2. Description of the Related Art

Recently, video on demand (VOD) services using cable facilities and asynchronous digital subscriber line (ADSL) are widely developed especially in the United States. In VOD services, an electronic merchandise receiving terminal is installed at home, and an electronic program guide (EPG) is displayed on the TV connected to the electronic merchandise receiving terminal. The viewer selects a desired content from the EPG, and views the picture.

A new technology is also developed for allowing individual users to customize a list of contents at the receiving terminal side. For example, U.S. Pat. No. 6,434,747 B1 (in, for example, FIGS. 2 and 3) discloses a method and a system for providing customized media lists to users via the network. According to this document, aside from contents such as a TV program and movies, advertising contents can be also customized for individual users.

Generally, MPEG2 technology used as CODEC is a technology originally standardized for emphasizing the real-time performance of encoding, and it consumes too much band for handling accumulated contents to be distributed by the VOD service, and is inferior in efficiency for providing services to multiple viewers in a limited band of backbone circuit. (Problem of band spending by CODEC)

Concerning distribution, in most cases, MPEG-TS designated in the digital video broadcast (DVB) specification is used. It is required to convert the protocol in order to distribute from the Internet utilizing the globally spread TCP/IP technology, which causes to increase the cost. Besides, contents aggregators for supplying contents to these existing VOD services are also based on the MPEG-TS format, and there is no known mechanism for allowing the contents owner to provide contents easily to the VOD services without resort to these contents aggregators. (Problem of distribution technology)

On the other hand, in VOD services using a personal computer (PC), by limiting the viewers (i.e., subscribers) to service providers, some of the movies and contents can be acquired and viewed, but since the number of latent customers is limited, services are not attractive enough with multiple contents. It is also one of the reasons why excellent contents are not widely available on the net that the PC is used as the terminal for viewing popular entertainment contents.

(Problem of Lack of Excellent Contents in VOD Services)

Various electronic media products (for example, software, music, etc.) utilizing the PC and Internet technology have been sold and executed for several years, but the visit sites on the Internet depend basically on the freedom of users, and methods for presenting electronic merchandise effectively to end users are not established yet. In the EPG for VOD services using TV, contents providers having various electronic media products have no means for providing merchandise information to viewers. (Problem of method for providing electronic merchandise)

By making use of the technology of the above document, the service may be improved to a certain extent, but most of the problems discussed above cannot be solved.

### BRIEF SUMMARY OF THE INVENTION

Embodiments of the present invention may provide an electronic merchandise distribution apparatus, an electronic merchandise receiving terminal, and an electronic merchandise distribution method capable of effectively providing electronic merchandise including pictures to end users.

According to one aspect of the present invention, there is provided an electronic merchandise distribution apparatus applied to a system including a plurality of terminals capable of receiving electronic program guide (EPG) and contents, and a plurality of access providers disposed between the electronic merchandise distribution apparatus and at least part of the plurality of terminals and capable of transmitting the EPG and contents to be distributed from the electronic merchandise distribution apparatus to the part of the plurality of the terminals which make contents viewing requests, the apparatus comprising an information management unit which acquires at least one of viewing information, preference information, and retrieval information of a user who uses one of the plurality of terminals; and a distribution management unit which stores non-real-time contents compressed by a CODEC, in an access provider corresponding to one of the plurality of terminals used by the user, based on the acquired at least one of the viewing information, preference information, and retrieval information of the user, prior to receiving the contents viewing request from the user.

According to another aspect of the present invention, there is provided an electronic merchandise receiving terminal capable of receiving electronic program guide (EPG) and contents distributed from an electronic merchandise distribution apparatus by way of an access provider, the terminal comprising a first processing unit which requests contents viewing to the access provider; and a second processing unit which receives contents stored in the access provider by the electronic merchandise distribution apparatus prior to the contents viewing request, from the access provider when requesting the contents viewing.

According to still another aspect of the present invention, there is provided an electronic merchandise distribution method applied to a system including a plurality of terminals capable of receiving electronic program guide (EPG) and contents, an electronic merchandise distribution apparatus capable of distributing the EPG and contents, and a plurality of access providers disposed between the electronic merchandise distribution apparatus and at least part of the plurality of terminals, and capable of transmitting the EPG and contents distributed from the electronic merchandise distribution apparatus to the part of the plurality of terminals which make contents viewing requests, the method comprising acquiring, by the merchandise distribution apparatus, at least one of viewing information, preference information, and retrieval information of a user who uses one of the plurality of terminals; and storing, by the merchandise distribution apparatus, non-real-time contents compressed by a CODEC, in an access provider corresponding to one of the terminals used by the user, based on the acquired at least one of the viewing information, preference information, and retrieval information of the user, prior to receiving the contents viewing request from the user.

According to still another aspect of the present invention, there is provided an electronic merchandise distribution method applied to a system which allows a supervising organization to distribute contents purchased from a contents provider to each of a plurality of electronic merchandise distribution apparatuses, and each electronic merchandise distribution apparatus to distribute the contents received from the supervising organization to electronic merchandise receiving terminals through a corresponding system operator, the method comprising deducting, by the system operator, own commission of the system operator from a contents usage fee collected from the electronic merchandise receiving terminals, and paying the remainder to a corresponding electronic merchandise distribution apparatus; deducting, by the electronic merchandise distribution apparatus, own commission of the electronic merchandise distribution apparatus from an amount paid from the system operator, and paying a remainder to the supervising organization; and paying, by the supervising organization, an amount obtained from the electronic merchandise distribution apparatus to the contents provider as a royalty.

According to still another aspect of the present invention, there is provided an electronic merchandise distribution method applied to a system which allows a first electronic merchandise distribution apparatus to distribute contents purchased from a contents provider to a second electronic merchandise distribution apparatus, and the second electronic merchandise distribution apparatus to distribute the contents received from the first electronic merchandise distribution apparatus to electronic merchandise receiving terminals through a system operator, the method comprising deducting, by the system operator, own commission of the system operator from a contents usage fee collected from the electronic merchandise receiving terminals, and paying a remainder to the second electronic merchandise distribution apparatus; deducting, by the second electronic merchandise distribution apparatus, own commission of the second electronic merchandise distribution apparatus from an amount paid from the system operator, and paying a remainder to the first electronic merchandise distribution apparatus; and deducting, by the first electronic merchandise distribution apparatus, own commission of the first electronic merchandise distribution apparatus from an amount paid from the second electronic merchandise distribution apparatus, and paying a remainder to the contents provider as a royalty.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a schematic configuration of an electronic merchandise distribution system according to one embodiment of the invention;

FIGS. 2A and 2B are block diagrams showing the detail of each configuration of an electronic merchandise distribution apparatus, a system operator (system), and an electronic merchandise receiving terminal;

FIG. 3 shows a first half of a general operation flow in the electronic merchandise distribution system;

FIG. 4 shows a second half of the general operation flow in the electronic merchandise distribution system;

FIG. 5 shows the execution sequence of a basic flow until a viewer purchases and views contents;

FIG. 6 is a diagram showing an example of data structure of channel information acquired in a log-in flow;

FIGS. 7A and 7B are diagrams showing the detail of the log-in flow;

FIGS. 8A and 8B are diagrams showing the detail of a contents retrieval flow;

FIGS. 9A and 9B are diagrams showing the detail of a contents purchase and viewing flow;

FIG. 10 is a diagram showing the detail of an advertisement viewing and preview contents viewing flow;

FIG. 11 is a diagram showing a screen composition of an electronic merchandise guide screen;

FIG. 12 is a diagram showing a data structure example of viewing information;

FIG. 13 is a diagram showing a data structure example of preference information;

FIG. 14 is a diagram showing a data structure example of operation history information;

FIG. 15 is a diagram showing an access control list example of viewing information;

FIG. 16 is a diagram showing an access control list example of preference information;

FIG. 17 is a diagram showing an access control list example of operation history information;

FIG. 18 is a block diagram showing an access control device;

FIG. 19 is a block diagram showing an electronic merchandise guide information management device;

FIG. 20 is a diagram showing an example of screen partition;

FIG. 21 is a diagram showing structure of electronic merchandise guide information data;

FIG. 22 shows a flow of registering new electronic merchandise;

FIG. 23 shows a flow of registering customized information;

FIG. 24 is a diagram showing an example of new electronic merchandise information;

FIG. 25 is a diagram showing an example of partition setting;

FIG. 26 is a flowchart of placing electronic merchandise on the electronic merchandise guide screen;

FIG. 27 is a flowchart of acquiring electronic merchandise information;

FIG. 28 is a diagram showing an example of tag;

FIG. 29 is a diagram showing a configuration of a contents retrieval device, etc.;

FIG. 30 is an operation flowchart of the contents retrieval device;

FIG. 31 is a diagram showing an example of input of preference information;

FIG. 32 is a diagram showing related items in contents meta information of movie A;

FIG. 33 is a diagram showing related data in contents meta information of movie B;

FIG. 34 is a diagram showing a technique of determining viewing points;

FIG. 35 is a diagram showing an example of contents meta information attributes;

FIG. 36 is a diagram showing a technique of calculating merit points of movie A and movie B;

FIG. 37 shows a first half of a pre-cache flow;

FIG. 38 shows a second half of the pre-cache flow;

FIG. 39 shows a general operation of pre-cache flow;

FIG. 40 is a diagram showing an example of hardware of the electronic merchandise receiving terminal;

FIG. 41 is a flowchart of player, presented service and service price;

FIG. 42 is a diagram showing classification of contents;

FIG. 43 is a diagram showing a connection format between a contents provider and the electronic merchandise distribution apparatus;

FIG. 44 shows a flow of distributing authorized contents;

FIG. 45 shows a flow of distributing unauthorized contents A;

FIG. 46 shows a flow of distributing unauthorized contents B;

FIG. 47 shows a flow of distributing private broadcasting station contents;

FIG. 48 shows a contents acquisition flow by an organization supervising electronic merchandise distribution apparatuses;

FIG. 49 is a diagram showing a concept of contents fee;

FIG. 50 is a flowchart of independent acquisition of contents by the electronic merchandise distribution apparatus; and

FIG. 51 is a diagram showing a concept of contents fee of contents acquired independently by the electronic merchandise distribution apparatus.

### DETAILED DESCRIPTION OF THE INVENTION

Embodiments of the present invention will be described below with reference to the drawings.

<Schematic Configuration of System>

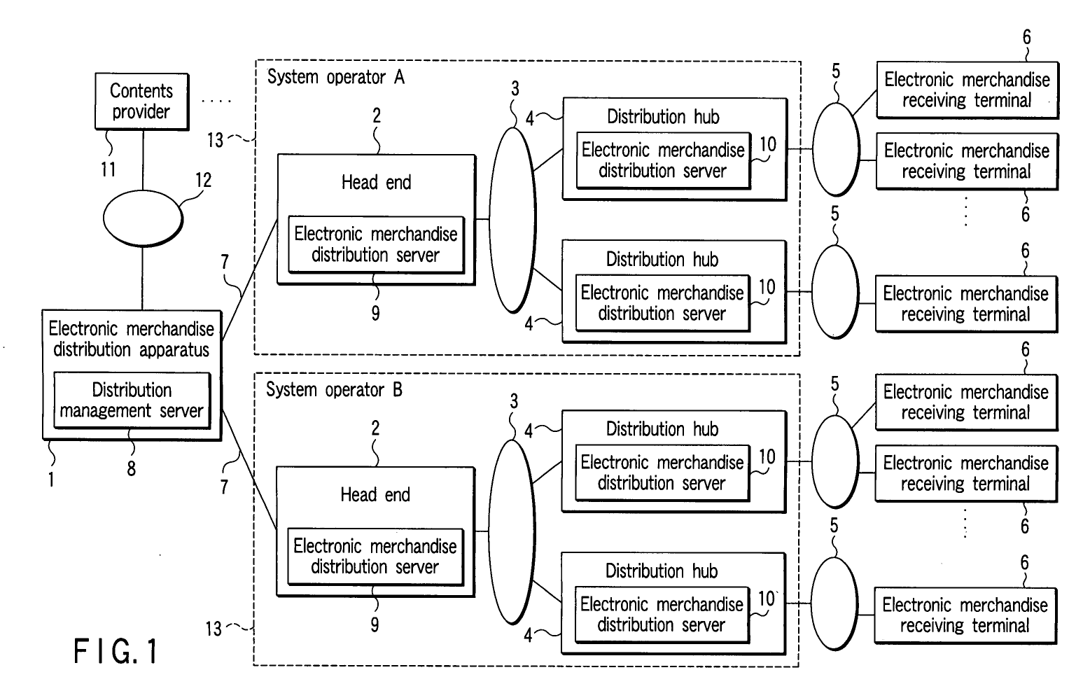

FIG. 1 is a block diagram showing a schematic configuration of an electronic merchandise distribution system in one embodiment of the invention. In this embodiment, the electronic merchandise distribution system is applied in a cable network.

An electronic merchandise distribution apparatus 1 acquires excellent contents from a contents provider 11 in the background of multiple latent subscribers belonging to multiple access providers (hereinafter called “system operators 13” because the following example relates to the cable network), and provides contents to the system operators 13. In FIG. 1, two system operators 13, that is, system operator (A) and system operator (B), are connected to the electronic merchandise distribution apparatus 1.

The electronic merchandise distribution apparatus 1 pre-caches individual contents (non-real-time contents compressed by a desired CODEC), depending on the excellence of contents, in an electronic merchandise distribution server in the system operator 13. Further, an electronic merchandise guide is created and distributed to subscribers of the system operator 13 as a sales screen of electronic merchandise depending on the individual preference information. It further includes a digital rights management (DRM) system and various management systems. In the electronic merchandise guide, a screen is formed according to the preference of the individual subscriber, and is presented to the subscriber, and there is also a function allowing the subscriber to customize the information area (“my channel” function).

A cable head end system 2 (hereinafter called head end 2) includes a receiving device for digital signals, an encoder for analog signals, a multiplexing device and modulating device for these signals, and various management systems. In the embodiment, in particular, an electronic merchandise distribution server 9 is provided. The head end 2 is connected to a distribution hub 4 connected to subscribers in local districts by way of a ring network or the like, and distributes contents to the corresponding distribution hub 4.

The network 3 is, for example, an optical ring, and is intended to connect the distribution hub and the head end. The network 3 is usually connected by using synchronous optical network (SONET) or DWMD technology.

The distribution hub 4 is a facility for connecting terminals of multiple subscribers in each local district by using hybrid fiber coax (HFC) network. Generally, the distribution hub has a cable modem termination system (CMTS) or the like for the cable Internet. The embodiment incorporates, in particular, an electronic merchandise distribution server 10, a resource management server (described later) for confirming the network resource in the system operator, and the like.

An HFC 5 is a facility for connecting the distribution hub 4 and an electronic merchandise receiving terminal 6.

The electronic merchandise receiving terminal 6 is installed in the home of the viewer, and is required when receiving services of electronic merchandise. The electronic merchandise receiving terminal 6 transmits/receives various requests and contents to/from the distribution hub 4.

A network 7 is an exclusive line (back end circuit) for connecting the electronic merchandise distribution apparatus 1 and the head end 2 of the system operator 13, and it is realized, for example, by an optical ring. This network 7 connects and processes at a circuit speed preliminarily agreed and contracted between the electronic merchandise distribution apparatus 1 and the system operator 13. As the consumer communication protocol, TCP/IP widely used on the Internet is utilized.

A distribution management server 8 is installed in the electronic merchandise distribution apparatus 1, and has functions of managing the distribution contents created in the electronic merchandise distribution apparatus 1, and pre-caching the contents in the electronic merchandise distribution server installed in the head end 2 or distribution hub 4 on the basis of the subscriber preference information or viewing information.

An electronic merchandise distribution server 9 is a first electronic merchandise distribution server installed at the head end. This electronic merchandise distribution server 9 functions as a distribution server or merchandise downloading server depending on the type of electronic merchandise. Basically, the electronic merchandise distribution server 9 holds the contents other than the contents held in the electronic merchandise distribution server 10 installed in the distribution hub 4 closer to the subscriber.

The electronic merchandise distribution server 10 is a second electronic merchandise distribution server installed in the distribution hub 4. This electronic merchandise distribution server 10 is basically same as the electronic merchandise distribution server 9. However, when a terminal 6 connected to a certain distribution hub 4 requests to use the contents, the distribution management server 8 first checks whether or nor contents are available in the electronic merchandise distribution server installed in the distribution hub 4, and when the desired contents are available in the electronic merchandise distribution server of the distribution hub 4, the contents are distributed therefrom.

The contents provider 11 supplies contents to the electronic merchandise distribution apparatus according to the contract with the electronic merchandise distribution apparatus.

The network 12 is, for example, an exclusive line, optical ring, Internet or the like, and is used when the contents provider 11 supplies the contents to the electronic merchandise distribution apparatus 1. However, transfer of contents from the contents provider 11 to the electronic merchandise distribution apparatus 1 may be also executed off-line.

<Business Players and Service Contents>

Business players in the system of the embodiment, that is, roles and relationship of the contents provider 11, electronic merchandise distribution apparatus 1, and system operator 13 are described below.

Contents Provider 11

The contents provider 11 supplies contents (electronic merchandise) to the electronic merchandise distribution apparatus 1, and receives a royalty depending on the number of times of use. Contents include all digital products, such as movies, music, news, television programs, software for PC, electronic books, images, advertisement, and games, and the embodiment is intended to handle mainly movie contents.

Electronic Merchandise Distribution Apparatus 1

The electronic merchandise distribution apparatus 1 first encodes the contents acquired from the contents provider 11 by using CODEC compression technology suited to the accumulated contents. As a result, non-real-time contents compressed by a desired CODEC can be formed. In particular, the electronic merchandise receiving terminal 1 in the embodiment realizes processing such as encoding by combination of media processor and software CODEC. Accordingly, along with the progress of CODEC technology, the best CODEC can be always utilized. (Solution of problem of band spending by CODEC)

Concerning the distribution, by using the TCP/IP technology widely employed in the Internet, the lower layer protocol in the access provider and the Internet technology can be standardized, and the contents provider can be directly connected to the Internet. As a result, the barrier in sales of electronic merchandise by the contents provider is lowered.

Further, the electronic merchandise distribution apparatus 1, using the viewer preference information and viewing information, pre-caches the non-real-time contents compressed by desired CODEC in the electronic merchandise distribution server 10 installed in the head end 2 or distribution hub 4 in the system operator 13. When the viewer requests viewing, contents are distributed from the appropriate distribution server 9 or 10. It hence solves the problem of bottleneck of distribution backbone. (Solution of problem of distribution technology)

The electronic merchandise distribution apparatus 1 bundles a great number of contents providers 11, and supplies the contents provided by the contents providers to the subscribers (viewers) connected to multiple system operators 13 contracted with the electronic merchandise distribution apparatus 1. Therefore, for the contents providers 11, the electronic merchandise distribution apparatus 1 regards the subscribers of the multiple system operators 13 as latent users of contents, whereby the number of times of use can be predicted, and since each system operator is basically a closed network, illegal copy of contents can be prevented or illegal copy can be tracked easily, so that the security is high. Therefore, excellent contents can be obtained from the contents providers 11. (Solution of problem of lack of excellent contents)

Moreover, the electronic merchandise distribution apparatus 1 provides a retrieval function by genre or free word so that viewers of the system operators 13 can search desired contents.

System Operator 13

The system operator 13 enrolls subscribers to Internet services. The service in the embodiment is value-added service to subscribers, and may be regarded as a characteristic service for registering new subscribers to the Internet.

The system operator 13 provides an electronic merchandise receiving terminal 6 to a subscriber, and provides services mainly by selling contents. The subscriber connects the TV to the electronic merchandise receiving terminal 6, manipulates the electronic merchandise guide shown on the TV monitor by a remote controller, searches desired contents, tries to use, and finally purchases.

The subscribers can enjoy the following services.

1) Use of varied contents acquired by the electronic merchandise distribution apparatus

2) Use of electronic merchandise guide for selecting desired contents from the contents

3) Trial use and purchase of contents from electronic merchandise guide

4) Individual customizing of electronic merchandise guide

Since the electronic merchandise guide is provided through the TV, in respect that the catalog (list) and types of merchandise are visually exhibited to the viewers, basically, this is a push-type distribution. For the contents provider 11, the contents previously sold on the Internet by pull-type distribution are sold by push-type distribution, so that it is expected to expand latent customers. (Solution of problem of presentation of electronic merchandise)

As explained above, the system of the embodiment solves the problems of the conventional system. As a result, the viewers can view versatile global contents which have not been achieved in the conventional service, and can utilize by simple operation, so that the customer satisfaction is enhanced. As synergistic effects, consequently, since it is expected to gather more customers, sales chances of contents providers are increased. For each business player, a system for promoting supply and demand of contents can be realized.

<Specific Configuration of System>

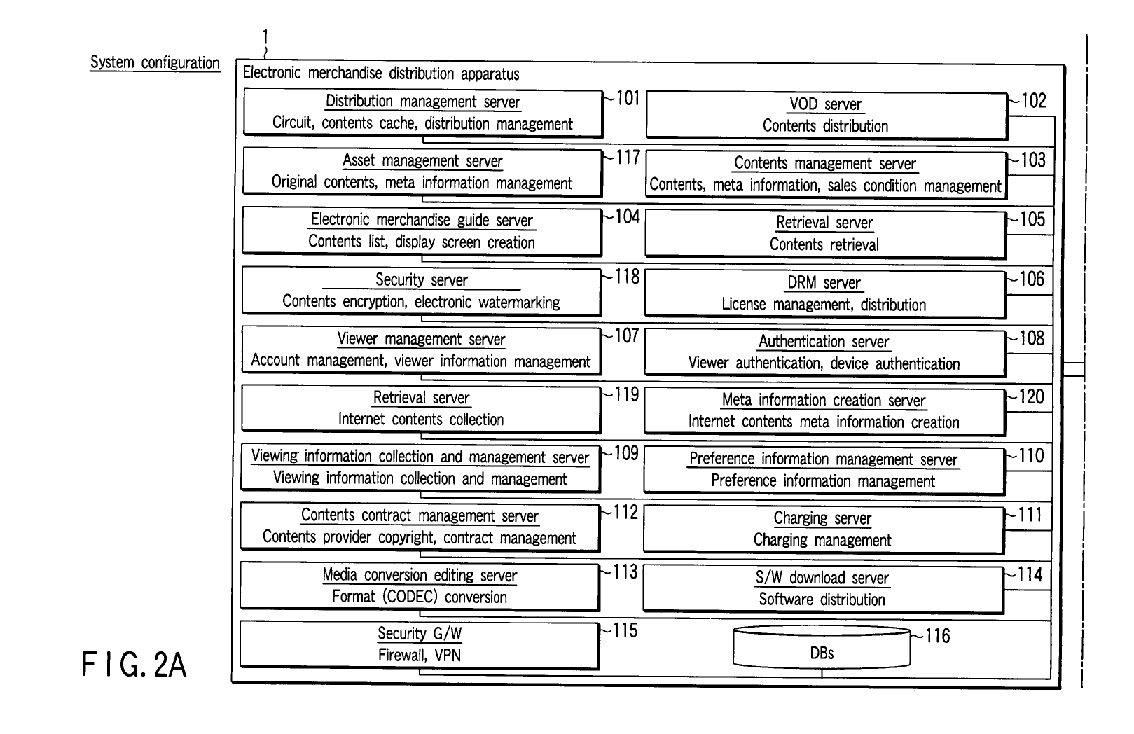

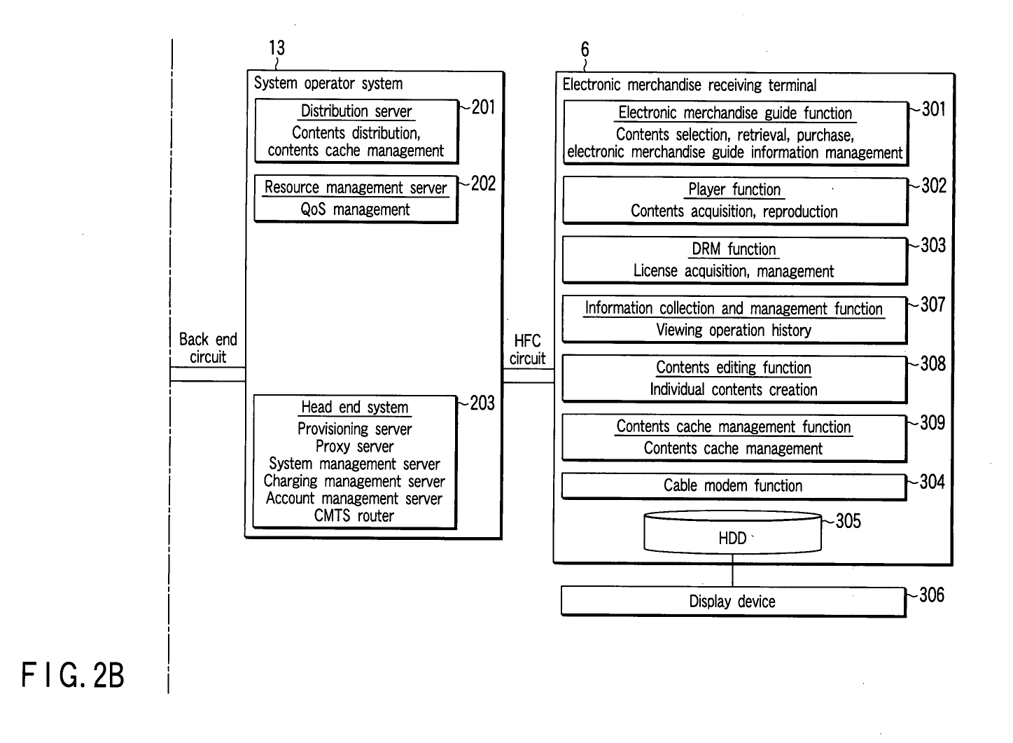

Referring now to FIGS. 2A and 2B, the detail of configurations of the electronic merchandise distribution apparatus 1, system operator (system) 13, and electronic merchandise receiving terminal 6 will be described.

A distribution management server 101 corresponds to the distribution management server 8 shown in FIG. 1, and is responsible for circuit quality management of a backbone circuit which connects the electronic merchandise distribution apparatus 1 and the system operator 13, and cache management and distribution management of contents.

An electronic merchandise distribution server (VOD server) 102 is for distributing contents, that is, electronic merchandise.

A contents management server 103 functions to manage the entity of contents, meta information of contents, and sales conditions of contents.

An electronic merchandise guide server 104 creates a list and display screen of contents to be provided to the viewers.

A retrieval server 105 is for searching contents depending on request.

A DRM server 106 issues licenses of contents and distributes to viewers.

A viewer management server 107 manages the account of viewers.

An authentication server 108 authenticates viewers and the electronic merchandise receiving terminals used by the viewers.

A viewing information collection and management server 109 collects and manages viewing information of viewers.

A preference information management server 110 manages preference information of viewers.

A charging server 111 manages accounting of contents and services viewed and utilized by viewers.

A contents contract management server 112 manages about the contents contract conditions (royalty contract, etc.) and copyright conditions (rights of secondary use) with the contents provider 11.

A media conversion edit server 113 converts the contents format obtained from the content provider 11 to another format (distribution format, etc.).

A software (S/W) download server 114 upgrades the application software in the system operator management server and the electronic merchandise receiving terminal of electronic merchandise receiving terminal management.

A security gateway (G/W) 115 is installed at the connection point when connecting the electronic merchandise distribution apparatus 1 with the contents provider 11, system operator 13, or the Internet, and provides security function.

A database (DB) 116 includes presentation DB, meta information DB, advertisement data DB, viewer management DB, viewing information DB, preference information DB, sales condition DB, and contents DB, and each is managed by the corresponding server.

An asset management server 117 stores the contents and contents meta information acquired from the contents provider 11.

A security server 118 protects the contents to be distributed by encrypting or electronic watermarking.

A retrieval server 119 searches contents existing on the Internet, and collects the contents and peripheral information (text document explaining the contents).

A meta information generation server 120 generates meta information of the corresponding contents from the collected peripheral information.

A distribution server 201 corresponds to the electronic merchandise distribution servers 9, 10 explained in FIG. 1, and caches and distributes the contents to be distributed to viewers.

A resource management server 202 manages the circuit quality (QoS: quality of service) of the HFC circuit 5 for connecting the system operator system 13 and the electronic merchandise receiving terminal 6.

A head end (system) 203 corresponds to the head end 2 explained in FIG. 1, and manages the cable system, and it includes a previsioning server, a proxy server, a system management server, a charging management server, an account management server, and a CMTS router.

An electronic merchandise guide function 301 provides functions of selecting, searching and purchasing contents to be viewed, and function of managing information of electronic merchandise guide.

A player function 302 is for acquiring contents and reproducing in a display device 306.

A DRM function 303 is for managing the license necessary for reproducing contents.

A cable modem function 304 is for realizing cable connection with the system operator 13.

An HDD 305 is for storing the acquired contents, etc.

The display device 306 is for display and output of EPG and contents.

An information collection and management function 307 is for collecting and managing the operation history by viewers.

A contents editing function 308 supports contents editing by viewers.

A contents cache management function 309 caches contents in the HDD 305.

<Overall Operation Flow>

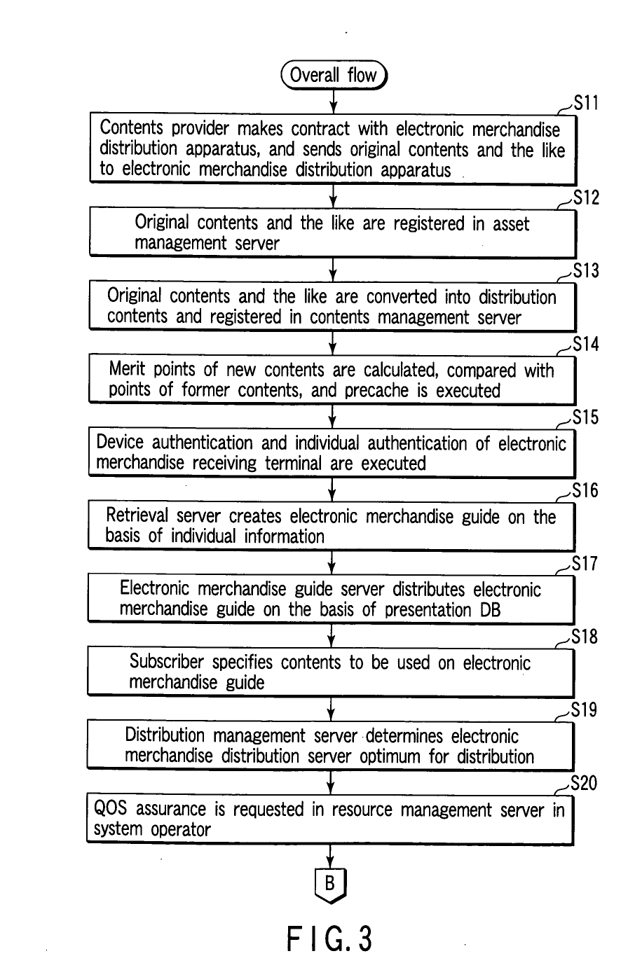

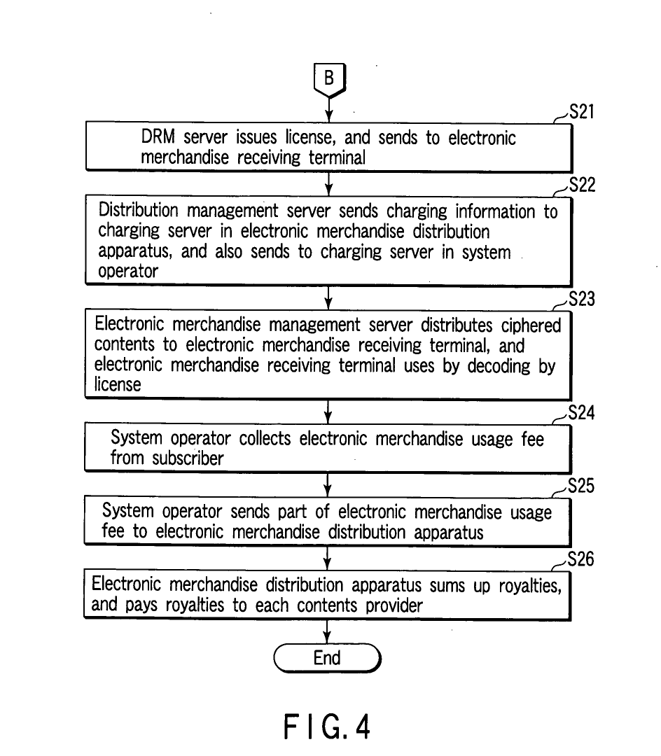

Referring next to FIGS. 2 and 3, an overall operation flow in the electronic merchandise distribution system will be described.

This is to explain an example of the overall operation flow of the contents provider 11 from distribution request (registration request) by the electronic merchandise distribution apparatus 1 to the system operator 13 under its control until acquisition of royalties for selling of contents.

Contents handled herein are contents registered and managed in the electronic merchandise distribution apparatus (authorized contents as described below). The flow of the capital refers only to the contents registration fee and contents service fee of the contents provider 11 in the electronic merchandise distribution apparatus 1, contents usage fee of viewers in the system operator 13 and other contents unit fees, but does not include the flow of the capital from the system operator 13 to the electronic merchandise distribution apparatus 1 arising from increase in the number of subscribers.

First, in step S11, the contents provider 11 contracts with the electronic merchandise distribution apparatus 1, and sends the own original contents and related meta information, or information about original contents to the electronic merchandise distribution apparatus 1. At the same time, the contents provider 11 pays the contents registration fee and contents service fee to the electronic merchandise distribution apparatus 1. Of the contents meta information, information relating to the contents themselves is stored in the contents meta information DB, and information relating to the contract is stored in the contents contract management server 112. The contents meta information specifies the contract (distribution) duration, distribution district, bit rate (original contents and distribution contents), resolution (original contents and distribution contents), minimum guarantee amount (MG), royalty amount, service contents (presented as VOD or SVOD (i.e., subscription VOD) contents), etc.

In step S12, in the electronic merchandise distribution apparatus 1, the original contents and original contents meta information are registered in the asset management server 117, and the contents meta information is registered in the contents management server 103.

In step S13, in the electronic merchandise distribution apparatus 1, according to the contract terms of the contents meta information, the original contents are converted into distribution contents by the media conversion editing server 113, and stored in the DB managed by the contents management server 103.

In step S14, the supervisory management server in the electronic merchandise distribution apparatus 1 acquires the distribution start timing from the contents contract management server 112 concerning newly registered contents. The supervisory management server calculates the merit rating of new contents before start of distribution, compares with the merit rating of contents pre-cached in the electronic merchandise distribution server installed in the system operator 13, and exchanges old and new contents.

At this time, the supervisory management server acquires viewing information from the viewing information collection and management server 109, preference information from the preference information management server 110, and promotion information contracted with the contents provider 11 from the contents contract management server 112, and the like, and measures the merit rating of the contents. The supervisory management server also checks the contract contents (the population of distribution contents differs in each system operator 13; for example, to distribute premium movie, the system operator 13 must pay a huge amount of contract fee to the electronic merchandise distribution apparatus 1) of the system operator 13 from the contents contract management server 112, and determines execution of pre-caching.

In step S15, when the subscriber turns on the power source of the electronic merchandise receiving terminal 6, first, the device of the electronic merchandise receiving terminal 6 is authenticated between the system operator 13 and the subscriber, and then the individual subscriber is authenticated by the authentication server 108 in the electronic merchandise distribution apparatus 1.

In step S16, after the individual authentication of the subscriber, the retrieval server 105 in the electronic merchandise distribution apparatus 1 compiles a distribution contents list for each type of contents (video, game, software, etc.) for the individual subscribers in order to create an electronic merchandise guide on the basis of individual information.

Types of desired contents preliminarily registered by the viewers and “my channel” screen information such as screen attributes are stored in the viewer management server 107, and the retrieval server 105 measures the merit rating by types of contents in cooperation with this information, viewing information collection and management server 109 and preference information management server 110, and compiles a recommended contents list.

Further, concerning contents demanding promotion in the contract with the contents provider 11, a promotion contents list is compiled from the contents meta information from the contents contract management server 112. Electronic merchandise guide distribution to the electronic merchandise receiving terminal 1 is executed by referring to this recommended contents list and promotion contents list.

In step S17, the electronic merchandise guide server 104 creates an electronic merchandise guide according to the contents distribution list compiled in step S16, and it is distributed to the electronic merchandise receiving terminal 6 by using the screen parts information held in the presentation DB managed by the electronic merchandise guide server 104.

In step S18, when the subscriber specifies desired contents on the electronic merchandise guide, the ID and purchase conditions of the desired contents are sent to the electronic merchandise distribution apparatus side.

In step S19, at the side of the electronic merchandise distribution apparatus 1, the distribution management server 101 acquiring the contents ID and subscriber ID confirms the position of the optimum electronic merchandise distribution server for distributing to the subscriber (including the head end, distribution hub, or HDD of electronic merchandise receiving terminal). (Herein, the electronic merchandise distribution server installed in the distribution hub is supposed to be optimum.)

In step S20, the distribution management server 101 inquires whether or not possible to guarantee the QoS (quality of service) between the subscriber and the electronic merchandise sales management server corresponding to the resource management server 202 in the system operator 13.

In step S21, when the QoS in the system operator 13 can be guaranteed, the electronic merchandise distribution apparatus 1 requests license issuing including cipher key to the DRM server, and then the license is issued, and sent to the electronic merchandise receiving terminal 6.

In step S22, when the distribution management server 101 sends a charging request to the charging server 111 in the electronic merchandise distribution apparatus 1, the charging server 111 sends the message to the charging management server and viewer management server 107 in the system operator 13.

In step S23, the distribution server 201 (electronic merchandise distribution server 10 installed in the distribution server 4 in FIG. 1) distributes the pre-cached and ciphered contents to the electronic merchandise receiving terminal 6, the contents are deciphered at the electronic merchandise receiving terminal 6 by using the preliminarily transmitted license, and displayed on the TV monitor.

In step S24, periodically, for example, at the end of every month, the system operator 13 issues a bill to the subscriber. The system operator 13 also claims sales of electronic merchandise to individual subscribes on the basis of the charging information (contents usage claim) sent from the electronic merchandise distribution apparatus 1.

In step S25, the system operator 13 remits the contents usage fees collected from the subscribers, minus the due charges of the system operator, to the electronic merchandise distribution apparatus 1.

In step S26, the electronic merchandise distribution apparatus 1 compares the number of times of usage of contents with the information of number of times of distribution managed in the own distribution management server 101 on the basis of the contents contract management server 112, classifies the contents usage fee in each contents provider 11, sums up in each of contents, and pays the royalties according to the number of times of use of contents in each contents provider 11. For a certain contents provider 11, only the result of summing up the number of times of use paid to the electronic merchandise distribution apparatus 1 is transmitted to the contents provider 11 in the form of minimum guarantee.

<Video Contents Flow (Log-In, Retrieval, Purchase and Viewing)>

The flow until the viewer purchases and views the contents will be explained. The overall flow includes the following four flows.

Log-in flow

Contents retrieval flow

Contents purchase, viewing flow

Advertisement viewing, preview contents viewing flow

As shown in FIG. 5, the execution sequence of the basic flow is log-in flow (step S31), contents retrieval flow (step S32), and contents purchase, viewing flow (step S33). Advertisement viewing, preview contents viewing flow (step S34) is a flow executed in relation to the log-in flow (step S31) or contents retrieval flow (step S32), and it is the process for acquiring and displaying the video advertisement or contents preview image to be displayed in the process in step S31 or step S32 from the electronic merchandise distribution apparatus.

Outline of each flow will be shown below.

The “log-in flow (step S31)” is a flow from logging into the system when the viewer turns on the power source of the electronic merchandise receiving terminal 1 until the electronic merchandise guide screen is displayed. The electronic merchandise distribution apparatus 1 executes authentication, and extracts recommended contents on the basis of the preference information or viewing information of the viewer.

The “contents retrieval flow (step S32)” is a flow from input of retrieval conditions about the desired contents to be viewed by the viewer until the contents suited to the retrieval conditions are searched and provided to the viewer. When plural results of retrieval are obtained, they are arranged and displayed in the sequence of conforming to the conditions on the basis of the viewing and preference information of the viewer.

The “contents purchase and viewing flow (step S33)” is a flow from selection of the desired contents by the viewer, followed by purchase process, until the contents and the corresponding license are distributed to the viewer and reproduced by the player function of the electronic merchandise receiving terminal.

The “advertisement viewing, preview contents viewing flow (step S34)” is a flow to be executed when necessary to display the video advertisement or preview video in step S31 or step S32. The video advertisement or preview video to be displayed are acquired from the electronic merchandise distribution apparatus, and displayed. In this flow, applicable contents are free contents such as advertisement or preview contents.

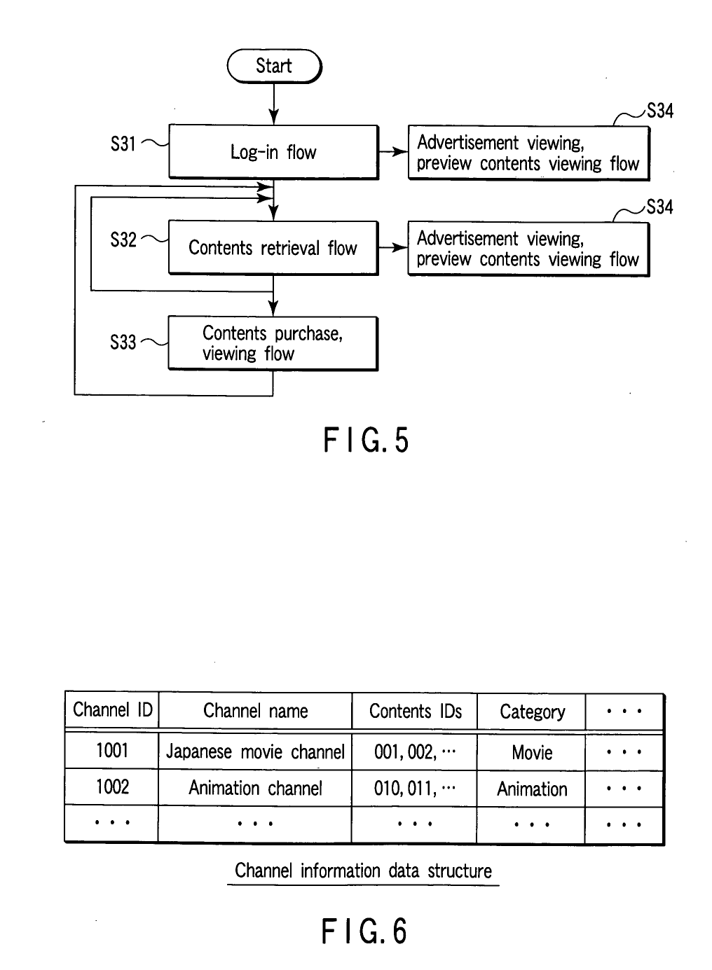

FIG. 6 is a diagram showing an example of a data structure of channel information acquired in the log-in flow. This will be described later.

<Detail of Log-In Flow>

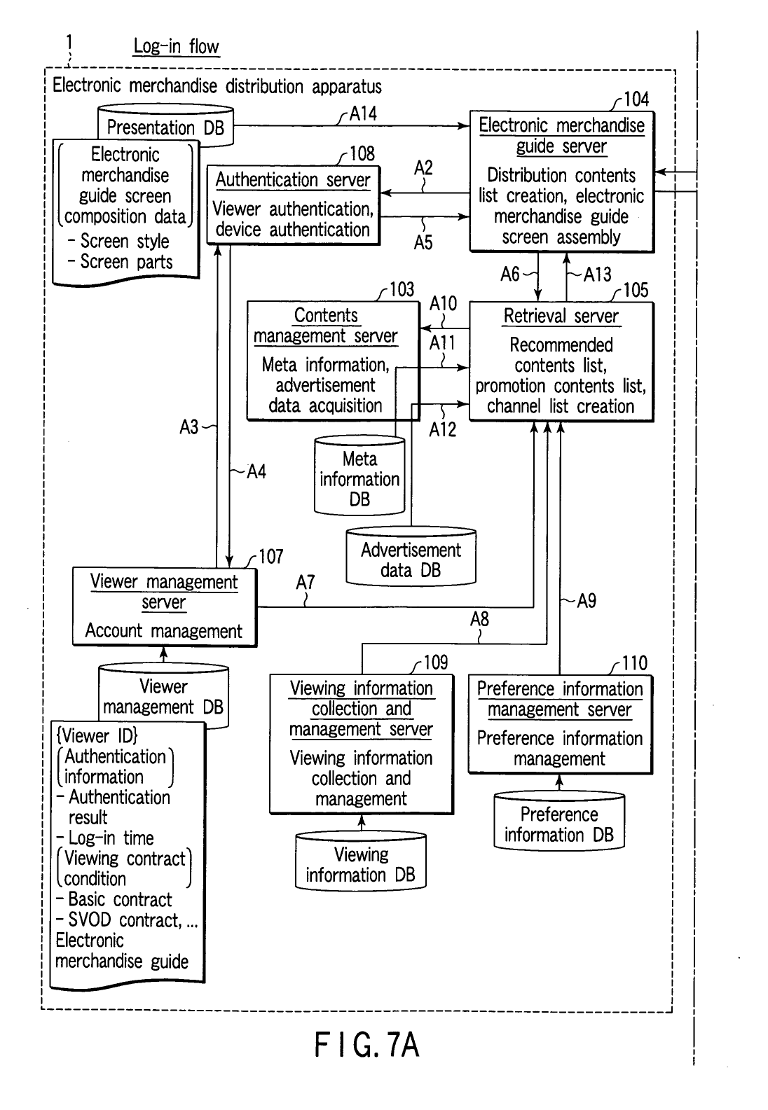

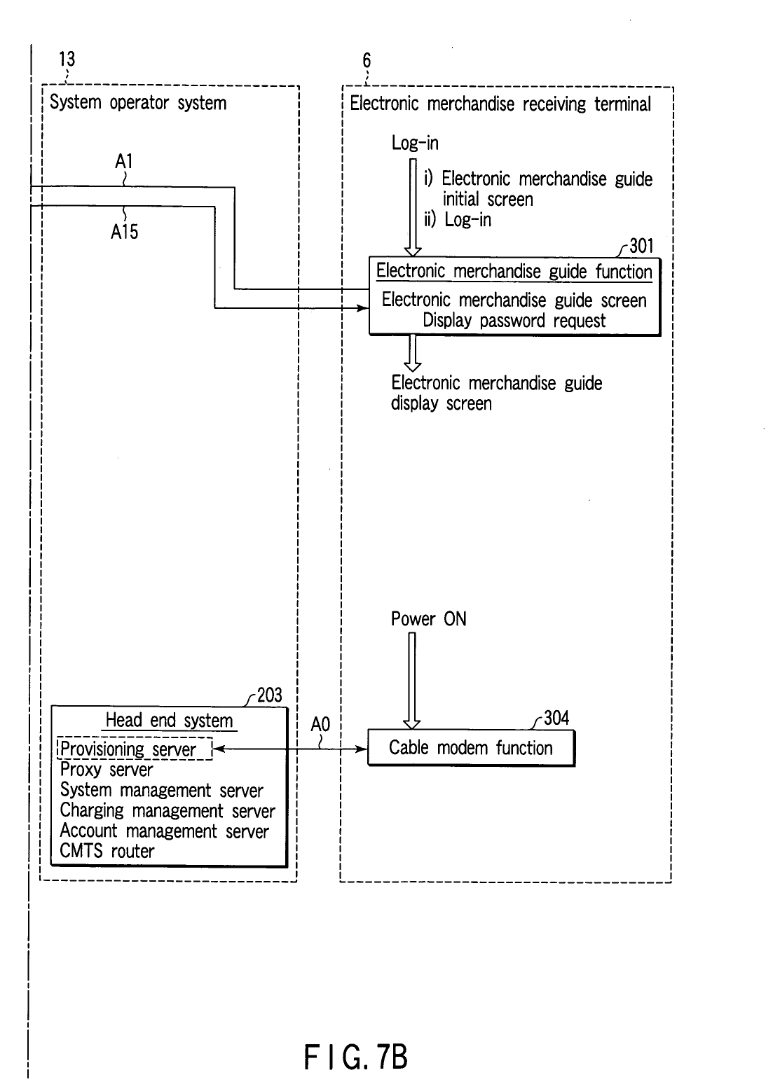

Referring now to FIGS. 7A and 7B, the detail of the log-in flow will be explained.

1. The power source of the electronic merchandise receiving terminal 3 is turned on, and the cable modem function 304 is activated.

2. The cable modem function 304 communicates with the provisioning server of the head end system 203, and prepares so as to be used on the HFC circuit. (A0)

3. The display device 306 shows an electronic merchandise guide initial screen urging to log in. However, log-in may not be always urged on the electronic merchandise guide initial screen. Generally, for log-in, the user name and password are inputted, but instead of inputting the user name, the icon identifying the user may be clicked. Further, instead of explicit input of password, the password already registered in the electronic merchandise guide function may be inputted implicitly. In this embodiment, a case where the user name and password are inputted is explained. (Log-in)

4. The electronic merchandise guide function 301 issues an authentication request to the electronic merchandise guide server 104. The authentication request includes the viewer authentication information containing a user name and password for identifying the viewer, and device information of the electronic merchandise receiving terminal and the like. The password may be transmitted either in plain text or in hashed password by hash process. The device information includes an identifier capable of identifying the electronic merchandise receiving terminal. By this identifier, an unauthorized electronic merchandise receiving terminal can be detected by the electronic merchandise distribution apparatus. In this embodiment, the user name and plain text password are used as the viewer authentication information, and MAC address of the electronic merchandise receiving terminal is used as the device information. (A1)

5. The electronic merchandise guide server 104 issues an authentication request to the authentication server 108. The authentication request includes the viewer authentication information and device information. The viewer authentication information and device information are same as acquired in the electronic merchandise guide server 104 in step 4. That is, in this embodiment, the viewer authentication information contains the user name and plain text password, and the device information contains the MAC address. (A2)

6. The authentication server 108 acquires the corresponding viewer information from the viewer management server 107 by using the identifier of the viewer (the user name in this embodiment) included in the viewer authentication information as the key. The viewer information includes the password of the viewer. Next, the authentication server 108 compares the acquired password of the viewer information and the password included in the viewer authentication information acquired in the step (A2). If the password obtained in the step (A2) is a hashed password, the obtained password of the viewer information is subjected to hash process and compared. As for the device information, similarly, the device information obtained from the viewer management server 107 and the device information obtained in the step (A2) (that is, MAC address in the embodiment) are compared and determined to be matched or not. When the viewer authentication information and device information are both matched, authentication is successful, but if not matched, authentication is failure. (A3)

7. The authentication server 108 transmits the result of authentication (success or failure) to the viewer management server 107. The viewer management server 107 stores the received authentication result in the viewer management DB. (A4)

8. The authentication server 108 notifies the electronic merchandise guide server 104 of the authentication result. (A5)

9. The electronic merchandise guide server 104 issues a recommended contents list request to the retrieval server 105. The recommended contents list is a list of contents recommended for viewers selected from the viewing information and preference information of viewers, and it is generated by the retrieval server 105. (A6)

10. The retrieval server 105 acquires the view contract condition and electronic merchandise guide information of the viewer from the viewer management server 107. The view contract condition includes basic contract, premium contract, and SVOD contract (channel unit contract, and all contents provided by the channel can be viewed at a uniform charge), and viewable contents vary with the contract. The electronic merchandise guide information includes the contents selected by the viewer, screen style, customizing setting and other information. For the viewer using the electronic merchandise guide, an existing screen style is provided, and the viewer can use this screen style, but can also customize the screen style for personal use by changing the display position or display color. Customizing information is stored as the electronic merchandise guide information. (A7)

11. The retrieval server 105 acquires the viewing information from the viewing information collection and management server 109. The viewing information includes viewing information of all viewers managed by the electronic merchandise distribution management apparatus. For example, the viewing information is acquired in the sequence of popular titles, such as [1: title A: action], [2: title B: suspense], [3: title C: action], [4: title D: SF], and so forth. Each title has a structure of [<ranking>: <title name>: <category>]. Suppose four titles are acquired in the embodiment. (A8)

12. The retrieval server 105 acquires the preference information of the corresponding viewer from the preference information management server 110. In this embodiment, [action] is assumed as the preference information of the viewer. It means that the viewer prefers action movies. That is, [action] is acquired as the preference information. (A9)

13. The retrieval server 105 requests meta information of contents and advertisement data to the contents management server 103. For example, in this embodiment, since the preference of the viewer is [action], search is executed in the contents management server 103 by category=[action]. To obtain the meta information corresponding to the title acquired in step 11, research is executed by using title A and title C of category=[action] as the search key. Concerning the advertisement data, the advertisement appealing to the viewer is estimated from the preference information, and the advertisement data is demanded. (A10)

14. The retrieval server 105 acquires contents meta information and channel information from the contents management server 103. For example, in this embodiment, meta information (*a) corresponding to category=[action] and meta information (*b) on the basis of viewing information are obtained. In retrieval on the basis of category=[action] and view information, channel information may be obtained in both meta information (*a) and meta information (*b). When a certain channel category is [action], for example, this channel is acquired as the channel information. (A11)

15. The retrieval server 105 acquires the advertisement data from the contents management server 103. There may be a plurality of advertisement data to be acquired. (A12)

16. The retrieval server 105 creates a recommended contents list from the acquired meta information (*a) and meta information (*b). When channel information is acquired, a channel list is created. The retrieval server 105 transmits the created recommended contents list and channel list and acquired advertisement data and electronic merchandise guide information to the electronic merchandise guide server 104. The recommended contents list is a list of contents suited to the preference of the viewer, and the channel list is a list of channels contracted for SVOD view. Herein, a channel is a concept of grouping plural contents, and, for example, a group of Japanese movie contents is a Japanese movie channel. The channel contains channel information, and its data structure is shown in FIG. 6. The channel information contains channel ID, channel name, contents ID (single or plural) contained in the channel, category, etc. The viewer can contract with plural channels for SVOD view.

The recommended contents list is created in the following process.

Rearrangement of sequence of presentation on the basis of viewing information and preference information of the viewer

Selection of contents depending on the viewing contract condition

The former is the process of presenting the contents suited to the preference of the viewer to the higher positions among plural contents, and the latter is the process of not presenting the contents that cannot be viewed by the view contract of the viewer. For example, for the viewer of basic contract only, contents that can be viewed only by premium contract are not presented. In creation of the channel list, similarly, channels containing contents to be viewed frequently are presented in higher positions as compared with other channels. (A13)

17. The electronic merchandise guide server 104 acquires the electronic merchandise guide screen composition data and promotion contents list from the presentation DB. The electronic merchandise guide screen composition data contains screen parts data and screen style data composing an electronic merchandise guide screen. The promotion contents list is a list of contents recommended to the viewer by the electronic merchandise distribution apparatus. (A14)

18. The electronic merchandise guide server 104 creates a distribution contents list to be distributed to viewers from the recommended contents list and channel list acquired from the retrieval server 105, and promotion contents list acquired from the presentation DB. Consequently, from the created distribution contents list and acquired electronic merchandise guide screen composition data, promotion contents list and advertisement data, an electronic merchandise guide screen is assembled.

19. The electronic merchandise guide server 104 transmits the assembled electronic merchandise guide screen to the electronic merchandise guide function 301. (A15)

20. The electronic merchandise guide function 301 displays the received electronic merchandise guide screen.

<Detail of Contents Retrieval Flow>

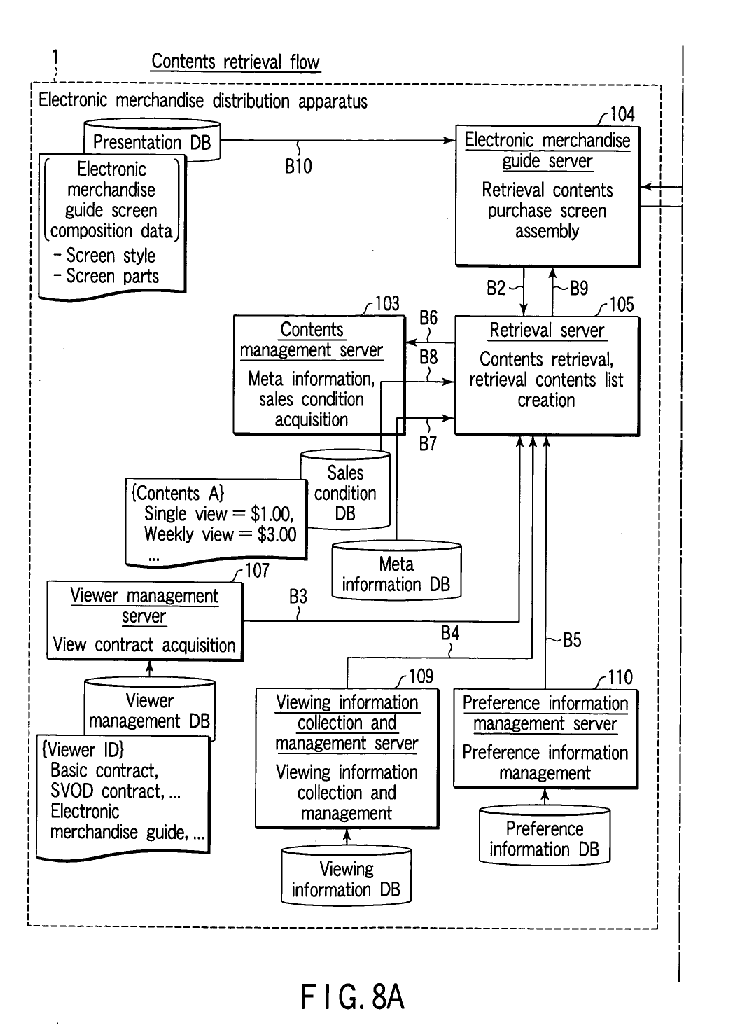

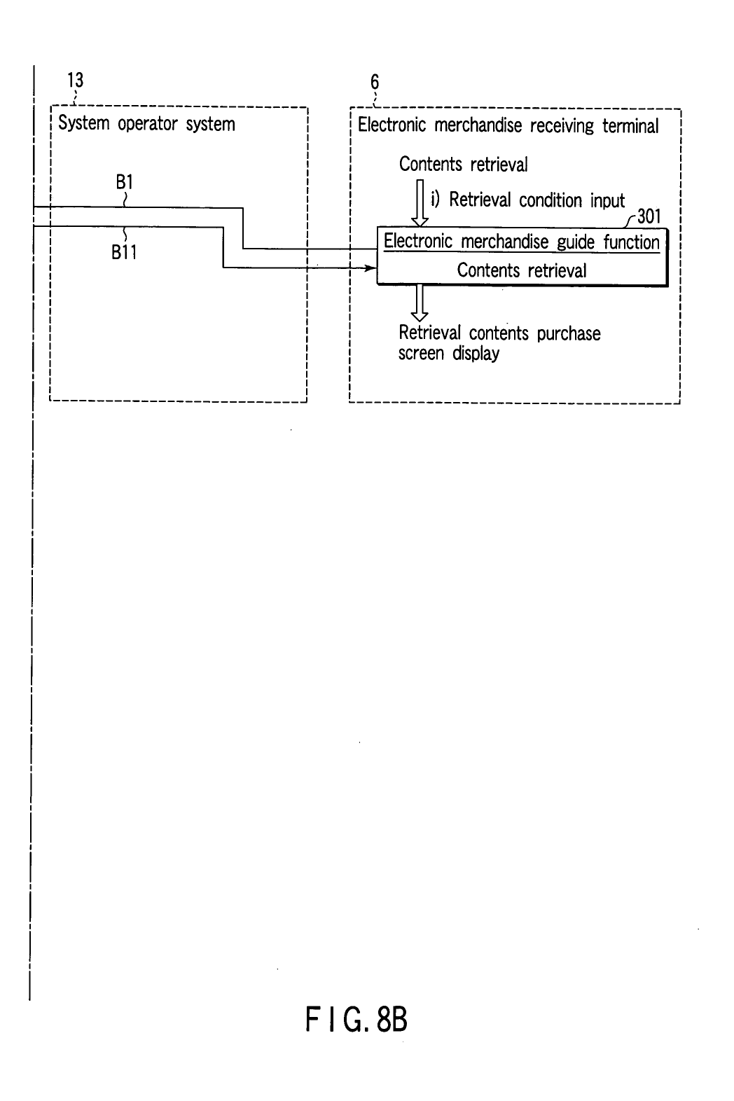

Referring next to FIGS. 8A and 8B, the detail of contents retrieval flow will be explained.

1. The viewer inputs the retrieval condition in the electronic merchandise guide function 301. In this embodiment, suppose the “movies preferred by the twenties” is designated as the retrieval condition.

2. The electronic merchandise guide function 301 issues a retrieval request to the electronic merchandise guide server 104. The retrieval request includes the retrieval condition. (B1)

3. The electronic merchandise guide server 104 issues a retrieval request to the retrieval server 105. (B2)

4. The retrieval server 105 acquires the view contract condition and electronic merchandise guide information of the corresponding viewer from the viewer management server 107. In the embodiment, suppose the viewer makes only the basic contract as the view contract condition. (B3)

5. The retrieval server 105 acquires the viewing information of “movies preferred by the twenties” from the viewing information collection and management server 109. For example, the viewing information is acquired in the sequence of titles such as [1: title A: action: basic contract], [2: title B: suspense: premium contract], [3: title C: action: basic contract], [4: title D: SF: basic contract] and so forth. Each title has a structure of [<ranking>: <title name>: <category>: <contract condition>]. The contract condition shows the condition capable of viewing the title. Suppose four titles are acquired in the embodiment. (B4)

6. The retrieval server 105 acquires the preference information of the viewer from the preference information management server 110. In the embodiment, [action] is assumed as the preference information of the viewer. (B5)

7. The retrieval server 105 demands contents meta information and sales condition from the contents management server 103. For example, in the embodiment, meta information and sales conditions of four contents acquired in step (B4) are demanded. (B6)

8. The retrieval server 105 acquires contents meta information from the contents management server 103. In the embodiment, the meta information of the four contents acquired in step 5 is obtained. (B7)

9. The retrieval server 105 acquires sales condition from the contents management server 103. The acquired sales condition corresponds to the contents meta information obtained in step (B7). The sales condition exists in each of contents, and includes, for example, the following.

Single view=$1.00

Weekly view=$3.00

These two sales conditions (purchase conditions for the viewer) indicate a single viewing costs one dollar, and that weekly viewing costs three dollars. (B8)

10. The retrieval server 105 creates a retrieval contents list from the acquired contents meta information, and transmits this retrieval contents list, sales condition and electronic merchandise guide information to the electronic merchandise guide server 104. The retrieval contents list is created in the following process.

Rearrangement of sequence of presentation on the basis of viewing information and preference information of the viewer

Selection of contents depending on the viewing contract condition

In the embodiment, of the four contents acquired in step 5, title A, title C, and title D that can be viewed in the basic contract are selected, and a retrieval contents list is created from these contents. (B9)

11. The electronic merchandise guide server 104 acquires electronic merchandise guide screen composition data from the presentation DB. (B10)

12. The electronic merchandise guide server 104 assembles a retrieval contents purchase screen from the retrieval contents list acquired from the retrieval server 105 and the acquired electronic merchandise guide screen composition data.

13. The electronic merchandise guide server 104 transmits the assembled retrieval contents purchase screen to the electronic merchandise guide function 301. (B11)

14. The electronic merchandise guide function 301 displays the received retrieval contents purchase screen on the electronic merchandise guide screen.

<Detail of Contents Purchasing and Viewing Flow>

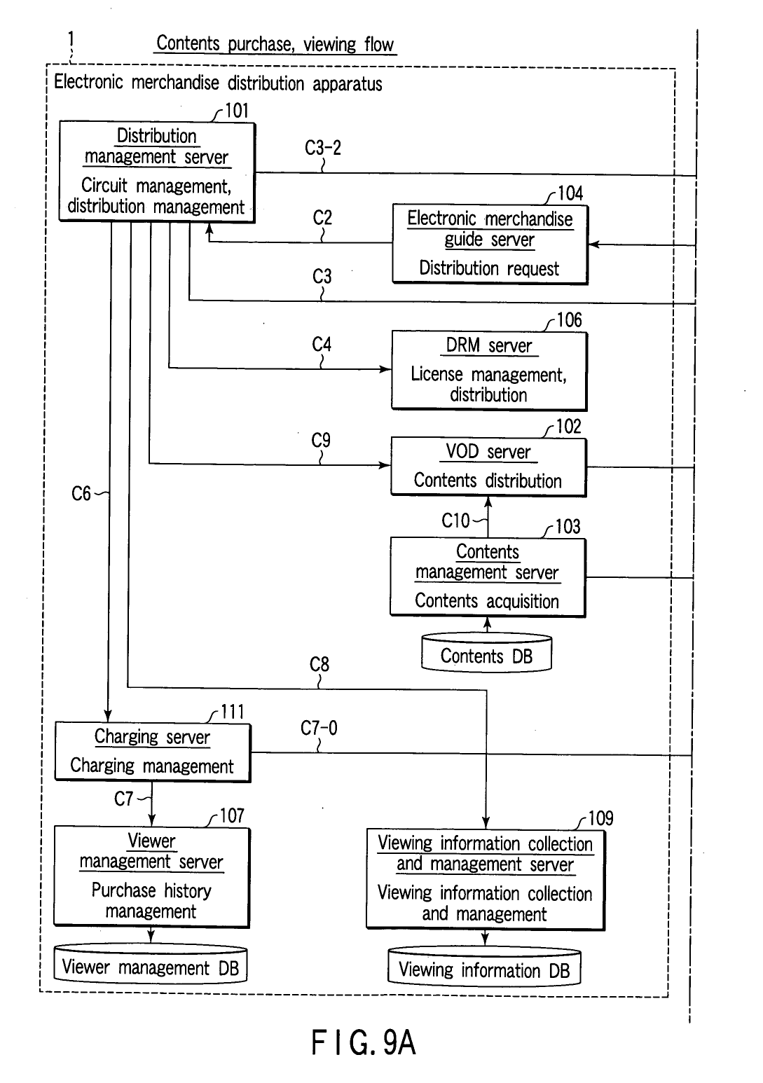

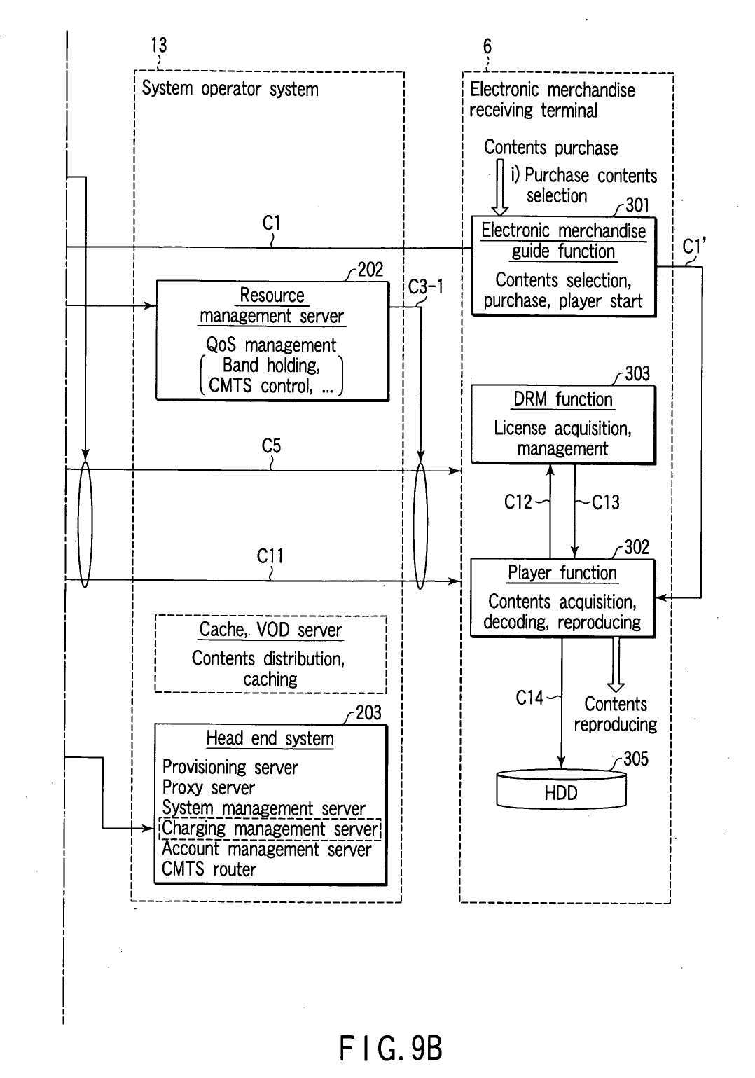

Referring now to FIGS. 9A and 9B, the detail of contents purchasing and viewing flow will be described.

1. The viewer selects desired contents from the contents list displayed on the electronic merchandise guide screen, and inputs the purchase condition.

2. The electronic merchandise guide function 301 starts up the player function 301 for acquiring the contents to be executed herein after. (C1′)

3. The electronic merchandise guide function 301 issues a purchase request to the electronic merchandise guide server 104. The purchase request includes the information and purchase condition of the selected contents. The contents information includes an identifier for identifying the contents. (C1)

4. The electronic merchandise guide server 104 issues a distribution request to the distribution management server 101. The distribution requests include the contents information and purchase condition. (C2)

5. The distribution management server 101 determines the source of contents distribution. Source of contents distribution comprises the following types.

1) Distribution server existing in contents provider

2) Distribution server existing in electronic merchandise distribution apparatus

3) Distribution server existing in system operator system (head end or distribution hub)

4) HDD existing in electronic merchandise receiving terminal

Contents distributed from the distribution server existing in the contents provider are authorized contents B or C. In the case of authorized contents A, they are distributed from 2), 3) or 4). Incidentally, the electronic merchandise distribution apparatus may be connected to a plurality of system operator systems, and the system operator system may be connected to a plurality of electronic merchandise receiving terminals. In such a case, there are a plurality of distribution servers and HDDs, and all these distribution sources are managed by the distribution management server 101. The distribution management server 101 determines the distribution source capable of distributing most efficiently among these distribution sources.

The QoS of the HFC circuit connecting the system operator system and the electronic merchandise receiving terminal is managed by the resource management server 202 of the system operator system, and the QoS of the back end circuit for connecting the electronic merchandise distribution apparatus and system operator system is managed by the distribution management server 101 of the electronic merchandise distribution apparatus. By way of the HFC circuit and back end circuit of which QoS is guaranteed, the subsequent process of license issue and contents distribution is executed.

Depending on the contents distribution source, the resource reserving circuit differs.

1) Distribution server of contents provider: back end circuit and HFC circuit

2) Distribution server of electronic merchandise distribution apparatus: back end circuit and HFC circuit

3) Distribution server of system operator system (head end or distribution hub): HFC circuit

4) HDD: none

In this flow, suppose the distribution management server 101 existing in the electronic merchandise distribution apparatus of 2) is determined as the distribution source.

6. The distribution management server 101 requests resource reserving of the HFC circuit to the resource management server 202. (C3)

7. The resource management server 202 reserves the resource of the HFC circuit. (C3-1)

8. The distribution management server 101 reserves the resource of the back end circuit. (C3-2)

9. The distribution management server 101 requests issue of license to the DRM server 106. The license issue request includes contents information and purchase condition. (C4)

10. The DRM server 106 creates license from contents information and purchase condition, and issues license to the DRM function 303. The license includes the contents cipher key and purchase condition. (C5)

11. The distribution management server 101 issues a charging request to the charging server 111. The charging request includes the purchase condition. (C6)

12. The charging server 111 issues a charging notice to the charging management server in the head end system 202. The charging notice includes the viewer information, contents information, and purchase condition. (C7-0)

13. The charging server 111 transmits the charging information to the viewer management server 107, and the viewer management server 107 stores the charging information in the viewer management DB. (C7)

14. The distribution management server 101 transmits contents information to the viewing information collection and management server 109, and the viewing information collection and management server 109 stores the corresponding contents information in the viewing information DB. (C8)

15. The distribution management server 101 requests distribution of contents to the distribution server 102. The contents distribution request includes contents information. (C9)

16. The distribution server 102 acquires the corresponding contents on the basis of the contents information from the contents management server 103. The contents management server 103 ciphers the contents acquired from the contents provider, and stores in the contents DB beforehand. The contents transmitted to the distribution server 102 from the contents management server 103 are preliminarily ciphered contents. (C10)

17. The distribution server 102 distributes the ciphered contents to the player function 302. (C11)

18. The player function 302 requests license to the DRM function 303. (C12)

19. The player function 302 acquires license from the DRM function 303. (C13)

20. The player function 302 decodes the contents by the cipher key contained in the acquired license, and displays the image of the contents in the display device 306. The acquired contents are stored in the HDD 305. At this time, the contents to be stored may be either ciphered contents or decoded contents. (C14)

<Detail of Advertisement Viewing and Preview Contents Viewing Flow>

The advertisement viewing and preview contents viewing flow is a flow to be executed together with the log-in flow or contents retrieval flow. In this flow, the electronic merchandise receiving terminal is required to have acquired the information for identifying the advertisement to be viewed or preview contents. In the log-in flow, the identifying information can be acquired by obtaining the distribution contents data and advertisement data included in the “my channel” screen. In the contents retrieval flow, the identifying information can be acquired by obtaining the retrieval contents included in the retrieval contents purchase screen. In the advertisement viewing and preview contents viewing flow, the video advertisement and preview contents to be viewed are free or non-secure contents. That is, these contents are free from charging process or DRM process.

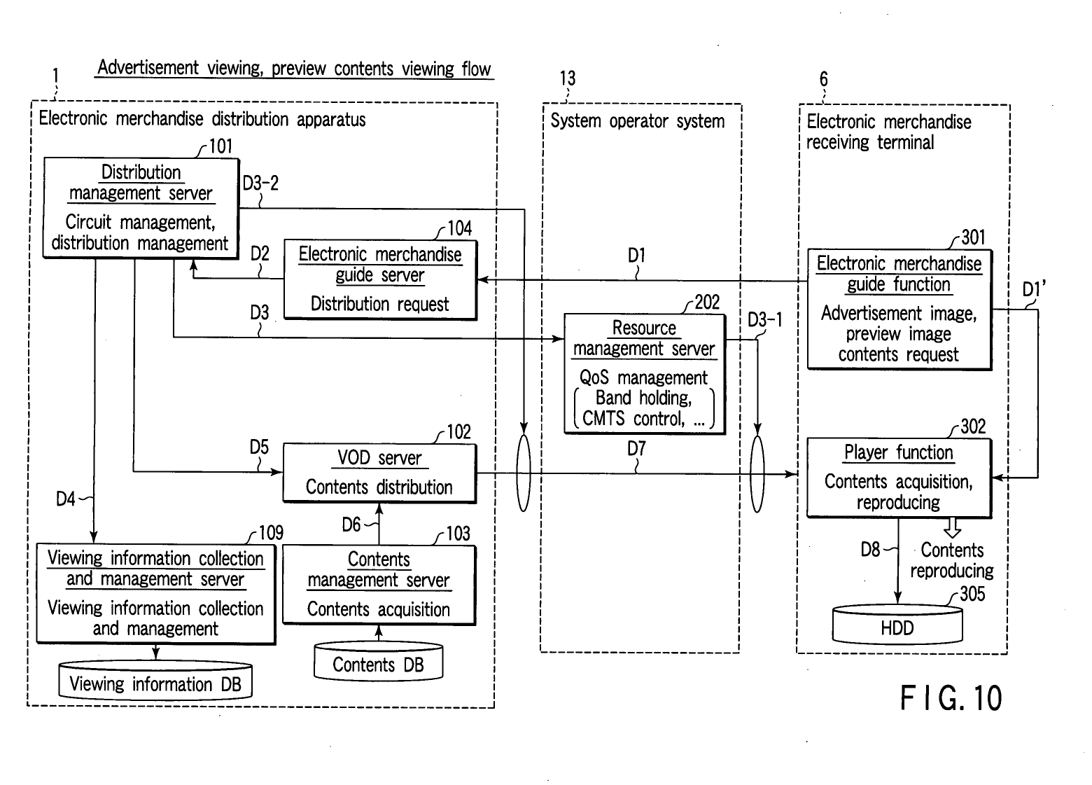

Referring to FIG. 10, the detail of advertisement viewing and preview contents viewing flow will be explained below.

1. The electronic merchandise guide function 301 requests contents from the electronic merchandise guide server 104. The contents request includes contents information of the advertisement or preview contents to be displayed. (D1)

2. The electronic merchandise guide server 104 issues a distribution request to the distribution management server 101. The distribution request includes content information. (D2)

3. The distribution management server 101 requests resource reserving of HFC circuit to the resource management server 202. (D3)

4. The resource management server 202 reserves the resource of HFC circuit. (D3-1)

5. The distribution management server 101 reserves the resource of back end circuit. (D3-2)

6. The distribution management server 101 transmits contents information to the viewing information collection and management server 109, and the viewing information collection and management server 109 stores the corresponding information in the viewing information DB. (D4)

7. The distribution management server 101 requests distribution of contents to the distribution server 102. The contents distribution request includes contents information. This system has three sources of distribution of advertisement or preview contents.

1) Distribution server existing in electronic merchandise distribution apparatus

2) Distribution server existing in system operation system (head end or distribution hub)

3) HDD existing in electronic merchandise receiving terminal

The distribution management server 101 manages the advertisement or preview contents to be distributed in any one of the three sources, and determines the destination source capable of distributing most efficiently to the viewers. In this flow, the distribution server existing in the electronic merchandise distribution apparatus is supposed to be determined as the distribution source. (D5)

8. The distribution server 102 acquires the corresponding advertisement or preview contents on the basis of the contents information from the contents management server 103. (D6)

9. The distribution server 102 distributes the advertisement or preview contents to the player function 302. (D7)

The player function 302 displays the image of the acquired advertisement or preview contents in the display device 306. The acquired advertisement or preview contents are stored in the HDD 305. (D8)

The electronic merchandise guide will be explained below.

<Function of Electronic Merchandise Guide>

The electronic merchandise guide is a user interface for comprehensively utilizing and managing the purchase of games and electronic books, and display of stock market or news, mainly using the EPG function. Features of the electronic merchandise guide include the following.

The screen composition can be customized according to the interest or preference of the user. Hence, the convenience is enhanced as compared with the conventional fixed screen composition.

Component elements on the screen are mutually related, and electronic merchandise information mainly using video contents can be effectively presented.

<Outline of Electronic Merchandise Guide>

The electronic merchandise guide mainly has the EPG function, together with various electronic merchandise services. The electronic merchandise includes music, news, software, electronic book, animation, still picture, game, and weather forecast, and the electronic merchandise provider provides electronic merchandise services. For example, an electronic music provider presents music information, sales or other services to users. An electronic merchandise provider can provide a single electronic product or plural electronic products.

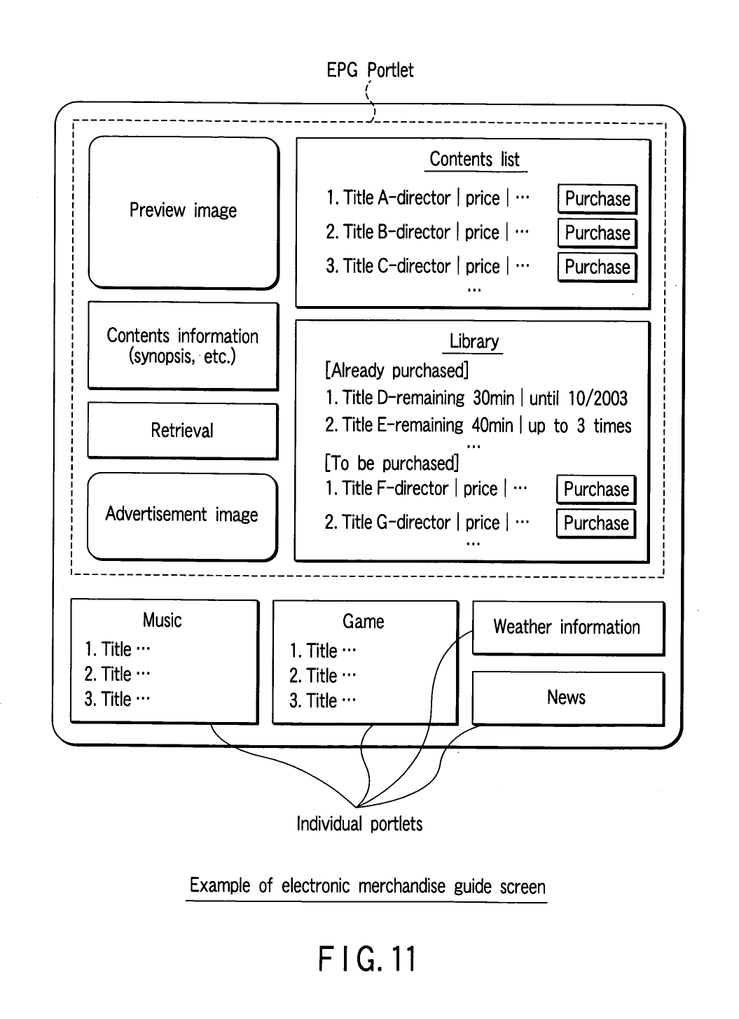

Referring now to FIG. 11, the screen composition of the electronic merchandise guide screen will be explained.

An electronic merchandise guide screen includes plural display windows called portlets. Each portlet is basically assigned in one genre of electronic merchandise, and occupies a certain region of the electronic merchandise guide screen, the portlets are not overlapped, but are displayed like tiles.

For the users, portlets are service interfaces of electronic merchandise items, and the location and content of each portlet can be customized.

Display items in a portlet can be set by the electronic merchandise provider, and the user can customize the display items in the portlet within the range permitted by the electronic merchandise provider. For example, in the weather information portlet, the user can display the weather in the interested region only out of the service area provided by the provider.

A screen example in FIG. 11 shows the EPG portlet providing the EGP in the center, together with various portlets of music, games, weather information, and news. Herein, each portlet is a rectangular region (but not limited to rectangle), and the EPG portlet is disposed in the upper part of the electronic merchandise guide screen, and portlets of music, games, weather information, and news are arranged in the lower part.

The layout of portlets will be described below.

The electronic merchandise guide screen is divided into lattice cells, and a portlet occupies one or plural cells. FIG. 20 shows a case of dividing into 3×3 cells. Each cell is assigned with a cell ID, and the portlet uses each cell exclusively. For example, the EPG portlet uses three cells, cell ID=1, 2, 3, the weather information portlet uses two cells, cell ID=4, 5, and the stock market information portlet uses one cell, cell ID=7. Not limited to 3×3, cells may be arbitrarily divided and assigned.

The EPG portlet will be described below.

The EPG portlet is a central portlet in the electronic merchandise guide screen, and comprehensively manages viewing of video contents, acquisition of information, display of related advertisement, purchase of contents, and management of contents. In the screen example in FIG. 11, the EPG portlet includes the following six subportlets.

Contents list display

Preview video display

Contents information display

Retrieval interface (retrieval condition input)

Advertisement video display

Library display

The EPG provider adds or deletes the EPG subportlets, and arbitrarily defines the function of subportlets. The user can select desired ones from these EPG subportlets, and designate the display position.

Contents list subportlet shows the promotion contents, recommended contents and channel list transmitted from the EPG server, and the results retrieved by the user.

In display of the promotion contents, recommended contents, contents by retrieval, the viewer can select desired contents, and the preview of selected contents is displayed in the preview video subportlet. Information of related contents may be displayed in the contents information subportlet.

In display of the channel list, a list of SVOD channels contracted by the user is shown. The viewer can select a desired channel, and the service guide screen of the selected channel is displayed. The service guide screen shows a list of contents provided in the selected channel. The viewer can select desired contents. Same as the promotion contents, the preview video of selected contents or contents information may be displayed.

In the retrieval subportlet, conditions for contents retrieval are inputted. The result conforming to the condition is displayed in the contents list subportlet.

The library subportlet is classified into the purchased contents and contents to be purchased, and manages them. The former is displayed together with the remaining playing time, effective viewing duration or remaining number of times of viewing if the content are in the midst of viewing, and the latter manages the contents remaining to be purchased.

<Screen Customizing (“My Channel” Function)>

For the user, various portlets for servicing electronic merchandise are provided, and the viewer can select a desired portlet, and disposed on the electronic merchandise guide screen. However, the EPG portlet may be disposed by priority in the upper part of the screen as the essential portlet, and other portlets may be disposed in the lower part of the screen, according to the restrictions of the electronic merchandise distribution apparatus. In this case, the sequence and size of the plural portlets disposed in the lower part of the screen can be changed by the viewer.

<Portlet Cooperation Function>

Each portlet can share the information mutually, and by sharing the information, each portlet can act by cooperation. The portlet cooperation function provides an access control function for limiting the electronic merchandise service providers capable of accessing the information.

The information as the object of access control will be described below.

1) Viewing information

2) Preference information

3) Operation history information

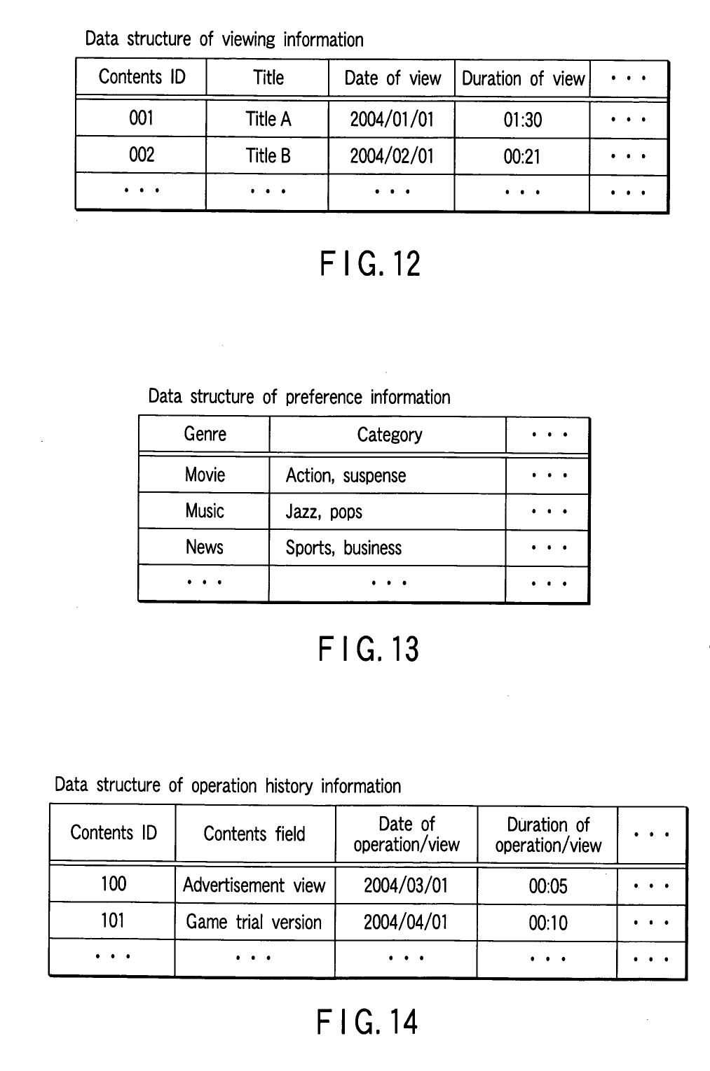

Viewing information is the viewing history of video contents, the preference information is the viewer preference category in each genre, and the operation history information is the operation history of the user on the electronic merchandise guide screen. Structural examples of these information data are shown in FIGS. 12, 13, and 14.

An access control list of each information will be described below.

The access control list is a list of definition of portlets and access rights permitted to access each information. The permitted portlet is specified by the portlet ID identifying the individual portlets, and assigned to each portlet by the electronic merchandise guide manager. The access right can set one or a plurality of the following three items.

Access right: reference (r), write (w), delete (d)

The reference (r) is the right to refer to items of each information, the write (w) is the right to write into items of each information, and the delete (D) is the right to delete items from each information.

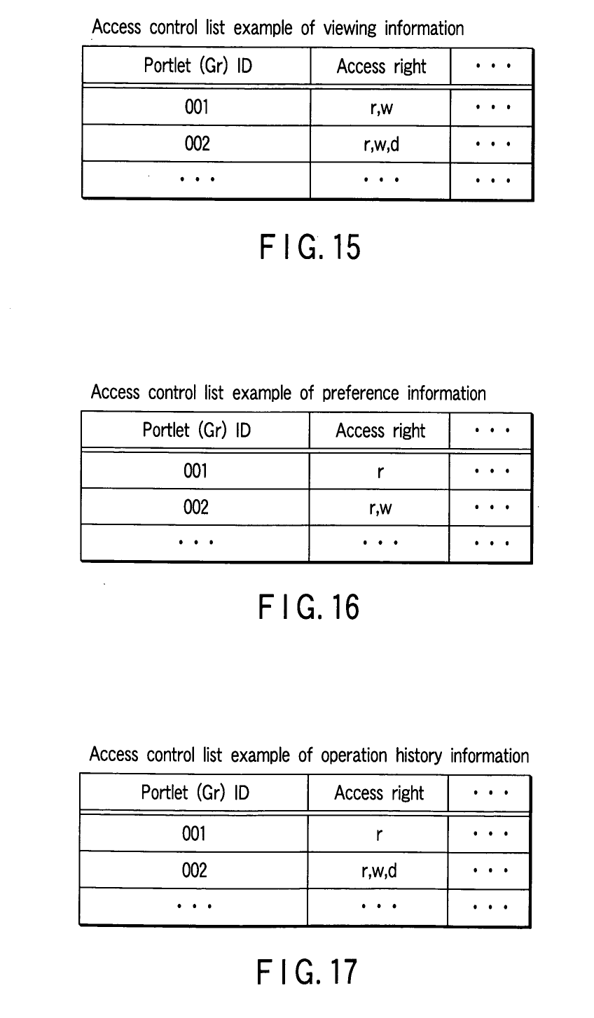

Examples of the access control list of each information are shown in FIGS. 15, 16, and 17.

For example, in the access control list example (FIG. 15) of viewing information, the portlet of portlet ID=001 is permitted to refer to and write the viewing information, and the portlet of portlet ID=002 is permitted to refer to, write or delete.

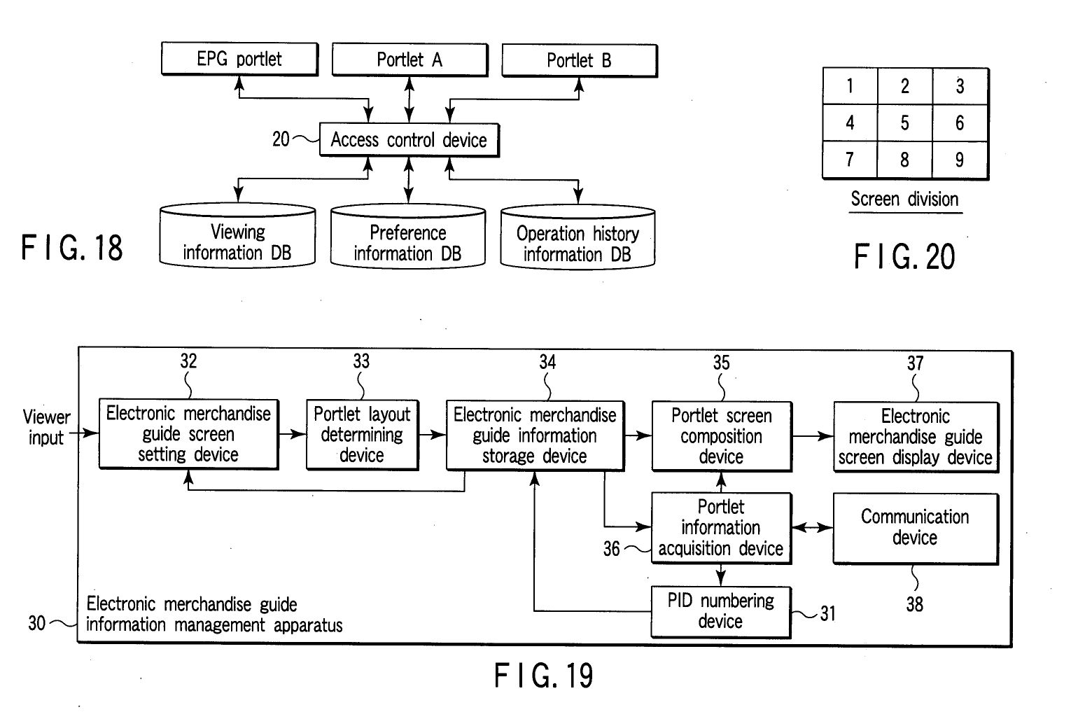

Access control is executed in an access control device 20 as shown in FIG. 18, and the access control device 20 is connected to each portlet and each information database (DB). By using the access control device 20 having such function, access operations to each information can be limited.

By sharing the information, for example, the cooperation function between the following portlets can be realized.

(Portlet Cooperation: Example 1)

The operation history of the user collected by the news portlet is fed back to the recommended contents to be provided by the EPG portlet. For example, if the user often looks up news particles about person A, this information is stored in the operation history information DB. The EPG portlet refers to the operation history information DB when determining the recommended contents, and determines that the user is interested in person A, and presents video contents relating to person A as recommended contents. In this case, if the viewer does not register person A explicitly as preference information, the preference information can be extracted from the operation history information.

(Portlet Cooperation: Example 2)

When the user views specific video contents, attributes about the video contents (director, actor, etc.) are stored in the viewing information DB or operation history information DB. Parallel with viewing of video contents, the news portlet refers to the information DB in which attributes are stored, and pre-caches the news relating to the attributes in the HDD of the client device parallel to the video contents viewing. The user can promptly view the news relating to the specific video contents during or after viewing from the HDD without having to newly acquiring from the news server.

<Purchase of Display Cell by Electronic Merchandise Provider>

The electronic merchandise provider can display the electronic merchandise in the specified cells of the electronic merchandise guide screen for presenting the appealing merchandise. For example, when the electronic merchandise guide screen is divided into 3×3 cells as shown in FIG. 20, the electronic merchandise provider uses two cells adjacent side by side, and specifies the pair of cell ID, by specifying, for example, (1, 2) when desired to display in the upper left corner, or (8, 9) to display in the lower right corner.

The electronic merchandise distribution apparatus sets the cell specified contract fee in each cell, and can collect the cell specified contract fee depending on the cell specified by the electronic merchandise provider. For example, when the contract fee of each cell is set as Pi (i=1 to 9; i is cell ID), in the case the cells of (1, 2) is specified, the cell specified contract fee of P1+P2 should be paid by the electronic merchandise provider to the electronic merchandise distribution apparatus.

Besides, when the own specified cell conflicts with the specified cell of another electronic merchandise provider, the electronic merchandise provider can designate whether or not to permit to display in other cell than the specified cell.

When the viewer desires to display two or more electronic products in a certain cell, a conflict occurs if this cell is included in the specified cell of two or more electronic products. In the event of conflict, the viewer must solve the conflict by, for example, moving the electronic merchandise permitted to be displayed in a cell other than the specified cell to a free cell, or not disposing any one of the conflicting electronic merchandise.

Incidentally, the electronic merchandise provider can display in an arbitrary cell without specifying display cell. In this case, collection of the cell specifying contract fee does not occur, and the display cell is determined by the electronic merchandise distribution apparatus or viewer.

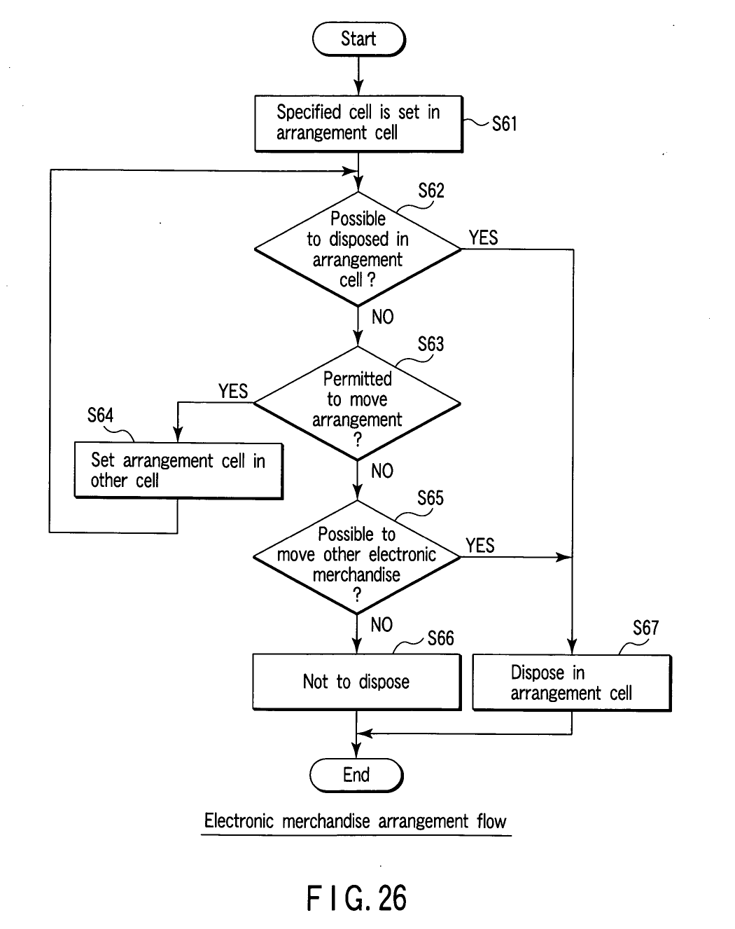

FIG. 26 shows a flow of disposing electronic merchandise on the electronic merchandise guide screen.

As shown in FIG. 26, the designated section is set in the disposing section (step S61), and it is determined whether or not it is possible to dispose in the disposing section (step S62). If possible to dispose, it is arranged to the disposing section (step S67). If not possible to dispose, on the other hand, it is determined whether or not to permit move of location (step S63). When permitted, setting a disposing section in other section (step S64), the process from step S62 is repeated. If not permitted, on the other hand, it is determined whether other electronic merchandise can be moved or not (step S65). If not possible to move, it is not disposed (step S66). If possible to move, it is disposed in the disposing section (step S67).

<Acquisition of Electronic Merchandise Information>

Information about electronic merchandise is displayed in the corresponding portlet, and the display content is updated appropriately. The updating timing is managed by the electronic merchandise receiving terminal, and the information is demanded to the electronic merchandise server as required.

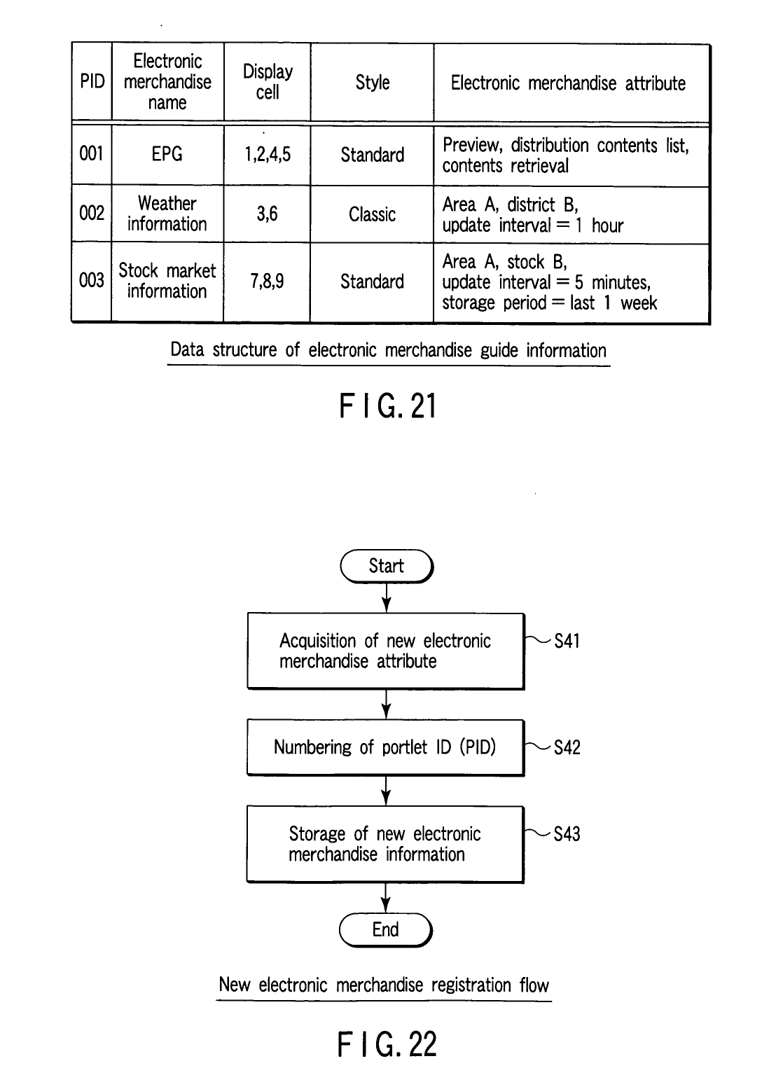

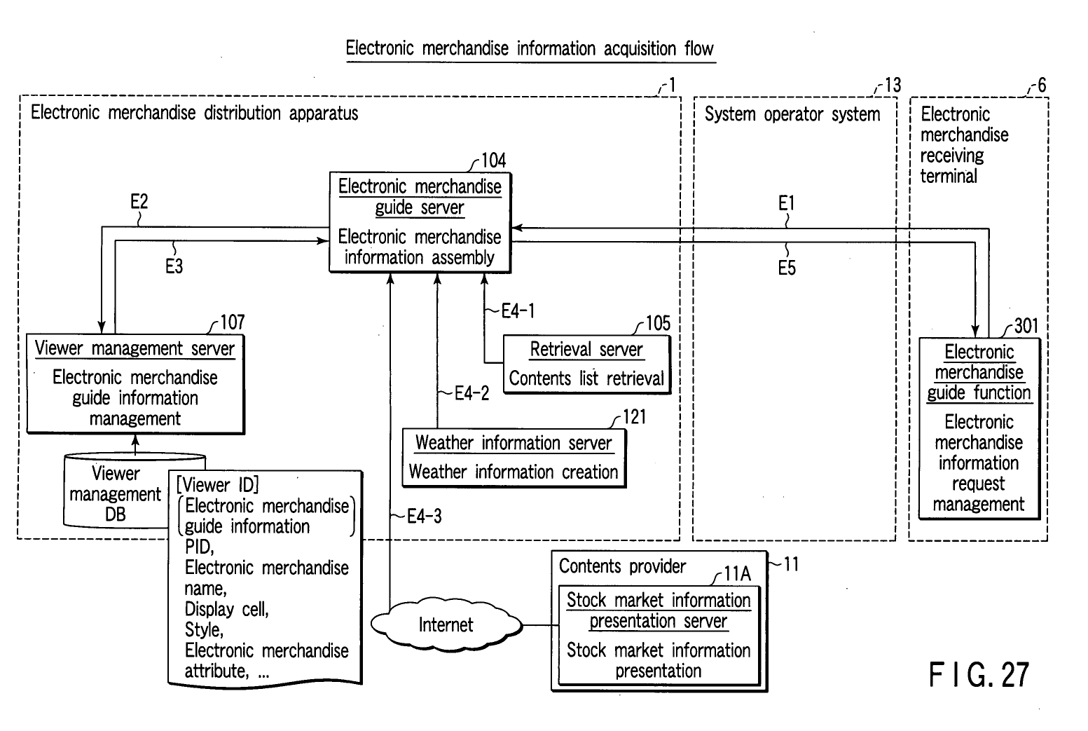

Herein, suppose three electronic products (EPG, weather forecast, and stock market information) are displayed on the electronic merchandise guide screen. The electronic merchandise guide information management device in the electronic merchandise receiving terminal 6 is shown in FIG. 19, the electronic merchandise guide information data structure is shown in FIG. 21, and the electronic merchandise information acquisition flow is shown in FIG. 27.

The electronic merchandise guide information is the information about the electronic merchandise or portlets displayed on the electronic merchandise guide screen, and is stored in the viewer management server 107 of the electronic merchandise distribution apparatus 1 and the electronic merchandise guide information management device 30 (realized by electronic merchandise guide function 301) of the electronic merchandise receiving terminal 6.

The electronic merchandise guide information management device 30 includes, as shown in FIG. 19, a PID numbering device 31 for numbering PID, an electronic merchandise guide screen setting device 32 for setting the electronic merchandise guide screen depending on the input from the viewer, a portlet layout determining device 33 for determining the portlet layout on the screen, an electronic merchandise guide information storage device 34 for storing the electronic merchandise guide information after determining the portlet layout, a portlet screen composing device 35 for composing the portlet screen, a portlet information acquiring device 36 for acquiring information about portlet, an electronic merchandise guide screen display device 37 for displaying the electronic merchandise guide screen having the portlet screen, and a communication device 38 for communicating in order to acquire portlet information.

The electronic merchandise guide information contains PID (portlet ID) displaying the electronic merchandise, electronic merchandise name showing the name of electronic merchandise, display cell as screen cell for displaying the portlet, style showing the style of portlet, and electronic merchandise attribute showing the attribute of the electronic merchandise.

An example of electronic merchandise attribute will be explained by referring to FIG. 21. In this example, the EPG (PID=001) indicates displaying the preview, distribution contents list, and contents retrieval, the weather information (PID=002) indicates displaying the weather information of area A and district B, updating the information every hour, and the stock market information (PID=003) indicates displaying stock A, stock B, updating information every 5 minutes, and storing the latest information in the past week. The viewer can change the display cell, style, and electronic merchandise attribute by customization.

The electronic merchandise guide information management device 30 is a device for composing the electronic merchandise guide function 301 (FIG. 2B) of the viewer management system, and executes (1) function of registering new electronic merchandise, (2) function of registering customizing information, and (3) function of acquiring and updating electronic merchandise information. The operation flow of each function is shown below.

1) Registration of New Electronic Merchandise

The electronic merchandise distribution apparatus 1 can provide new electronic merchandise to viewers, and transmits the information of the new electronic merchandise to the electronic merchandise receiving terminal 6. The electronic merchandise receiving terminal 6 stores and registers the transmitted information in the electronic merchandise guide information storage device 34 (FIG. 19), and the viewer can select the registered items of electronic merchandise.

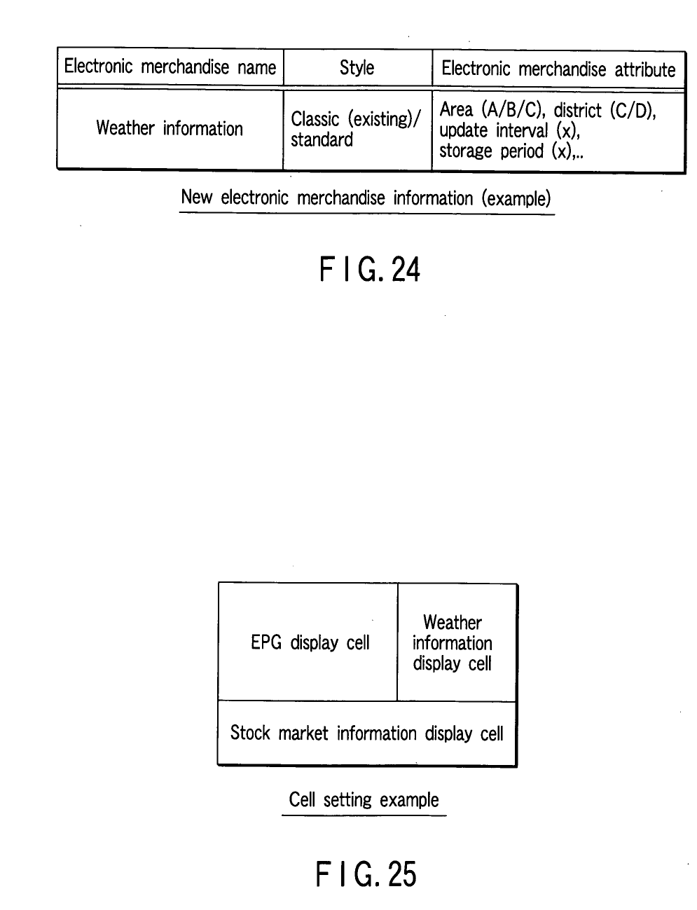

An example of information of new electronic merchandise transmitted by the electronic merchandise distribution apparatus will be shown in FIG. 24.

The new electronic merchandise includes electronic merchandise name, style, electronic merchandise attribute and the like, and the style and electronic merchandise attribute lists up item that can be selected or customized by the viewers. In this example, either classic or standard can be selected as the style, but the classic is selected as the existing style, and as the electronic merchandise attribute, the area can be selected from A, B and C, and the district can be selected from C and D, and the updating time and storage duration can be specified.

The flow of registering new electronic merchandise will be explained by referring to FIG. 22 (and FIG. 19).

In step S41, the electronic merchandise guide information management device 30 receives new electronic merchandise information from the electronic merchandise distribution apparatus 1. The new electronic merchandise information is put into the portlet information acquisition device 36 by way of the communication device 38.

In step S42, the portlet identifier (PID) to be assigned to the new electronic merchandise information is numbered and issued by the PID numbering device 31.

In step S43, the new electronic merchandise information is stored in the electronic merchandise guide information storage device 34.

2) Registration of Customized Information

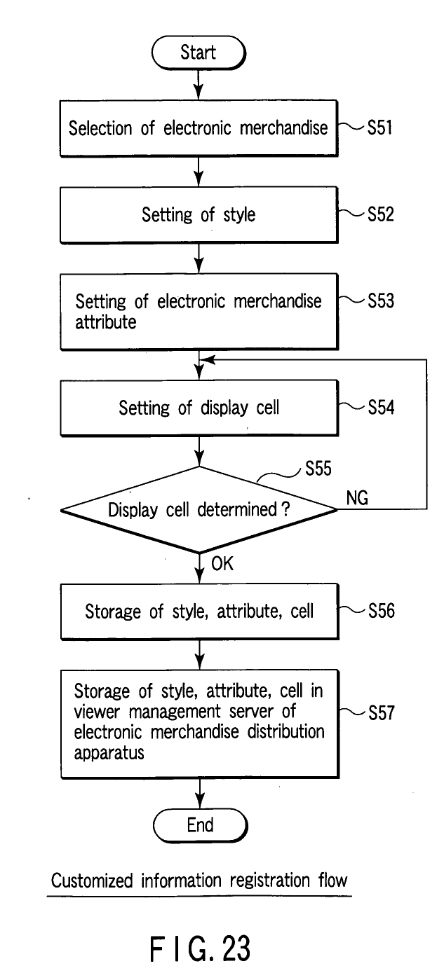

The viewer can select and customize the electronic merchandise displayed on the electronic merchandise guide screen, and the customized information is stored in the electronic merchandise guide information storage device and viewer management DB of the viewer management server. The flow of registering customized information will be explained by referring to FIG. 23 (and FIG. 19).

In step S51, electronic merchandise guide information is called from the electronic merchandise guide information storage device 34 into the electronic merchandise guide screen setting device 32. The viewer selects the electronic merchandise desired to be displayed from the electronic merchandise guide information by the electronic merchandise guide screen setting device 32. The selecting method includes the remote controller and other means.

In step S52, the style of the selected electronic merchandise is selected. The selecting method includes the remote controller and other means.

In step S53, the electronic merchandise attribute of the selected electronic merchandise is set. The selecting method includes the remote controller and other means.

In step S54, the display cell of the selected electronic merchandise is determined. The display area is divided into 3×3 cells, for example, as shown in FIG. 20, and a desired cell is specified. The cell is specified by numerical input or selection of position by cursor. The specifying or selecting method includes the remote controller and other means.

In step S55, it is determined whether the cell specified by the viewer can be displayed or not. In the event of conflict with the cell in which other electronic merchandise is displayed, back to step S54, the display cell is specified again. If not conflicting, step S55 is executed.

In step S56, the selected electronic merchandise, determined style, electronic merchandise attribute, and display cell are stored in the electronic merchandise guide information storage device 34.

In step S57, the electronic merchandise guide information including the selected electronic merchandise, determined style, electronic merchandise attribute and display cell is transmitted to the viewer management server in the electronic merchandise distribution apparatus, and stored in the database of the viewer management server.

For example, three items of electronic merchandise specifying the display cells as shown in FIG. 21 (EPG, weather forecast, stock market information) are displayed as shown in FIG. 25.

3) Acquisition and Updating of Electronic Merchandise Information

Information of electronic merchandise displayed on the electronic merchandise guide screen is updated from time to time. The electronic merchandise receiving terminal 6 issues an update request to the electronic merchandise server, and obtains updated information from the electronic merchandise server.

The flow of acquiring and updating electronic merchandise information will be explained by referring to FIG. 27 (and FIGS. 2A and 2B).

1. The electronic merchandise guide function 301 of the electronic merchandise receiving terminal 6 issues an electronic merchandise information request to the electronic merchandise guide server when requested to update the electronic merchandise displayed on the electronic merchandise guide screen. An update request occurs when the viewer requests update, or the updating interval is set in the electronic merchandise attribute of the electronic merchandise. The former occurs by contents retrieval request or the like, and the latter occurs periodically in every updating interval. For requesting, the PID of the electronic merchandise to be updated is transmitted. (E1)

2. The electronic merchandise guide server 104 requests electronic merchandise guide information (FIG. 21) to the viewer management server 107. (E2)

3. The viewer management server 107 acquires the electronic merchandise guide information corresponding to the viewer ID and PID from the viewer management DB. The acquired electronic merchandise guide information is transmitted to the electronic merchandise guide server 104. (E3)

4. The electronic merchandise guide server 104 acquires the electronic merchandise information from the electronic merchandise server corresponding to each electronic merchandise to be updated. For example, when the electronic merchandise is EPG, the EPG information is obtained as the electronic merchandise information from the retrieval server 105 which is the electronic merchandise server corresponding to the EPG (E4-1). When the electronic merchandise is weather information, the weather information is obtained as electronic merchandise information from the weather information server which is the electronic merchandise server corresponding to the weather information (E4-2). The electronic merchandise server may be located outside of the electronic merchandise distribution apparatus. In FIG. 27, the stock market information provider server 11A which is the electronic merchandise server of stock market information is connected to the electronic merchandise distribution apparatus 1 through the Internet. When acquiring stock market information, the stock market information is obtained from the stock market information provider server by way of the Internet (E4-3).

5. The electronic merchandise guide server 104 transmits the electronic merchandise information obtained from the electronic merchandise server to the electronic merchandise guide function 301. (E5)

6. The electronic merchandise guide function 301 displays the acquired electronic merchandise information in the corresponding display cell of the electronic merchandise.

<Contents Retrieval Function>

Contents retrieval function is a function of searching video contents dispersing in Web servers connected to the Internet (hereinafter called nonauthorized contents), and collecting and extracting meta information of nonauthorized contents.

The purpose of this function is not to collect the video contents, but to extract and register meta information of the contents so as to search nonauthorized contents.

In certain video contents, if there is a file for referring to the video contents (for example, html file), metal information is extracted from this file (hereinafter called reference file).

Meta information extracted by the retrieval function includes the following attributes.

Year of production, title, cast, director, producer, etc.

The reference file is described in the following format.

1) Structural Format

Pair of tag representing the attribute and the attribute value is described structurally (for example, xml format). The tag to be used must be specified beforehand.

2) Nonstructural Format

An attribute value is described in a free format.

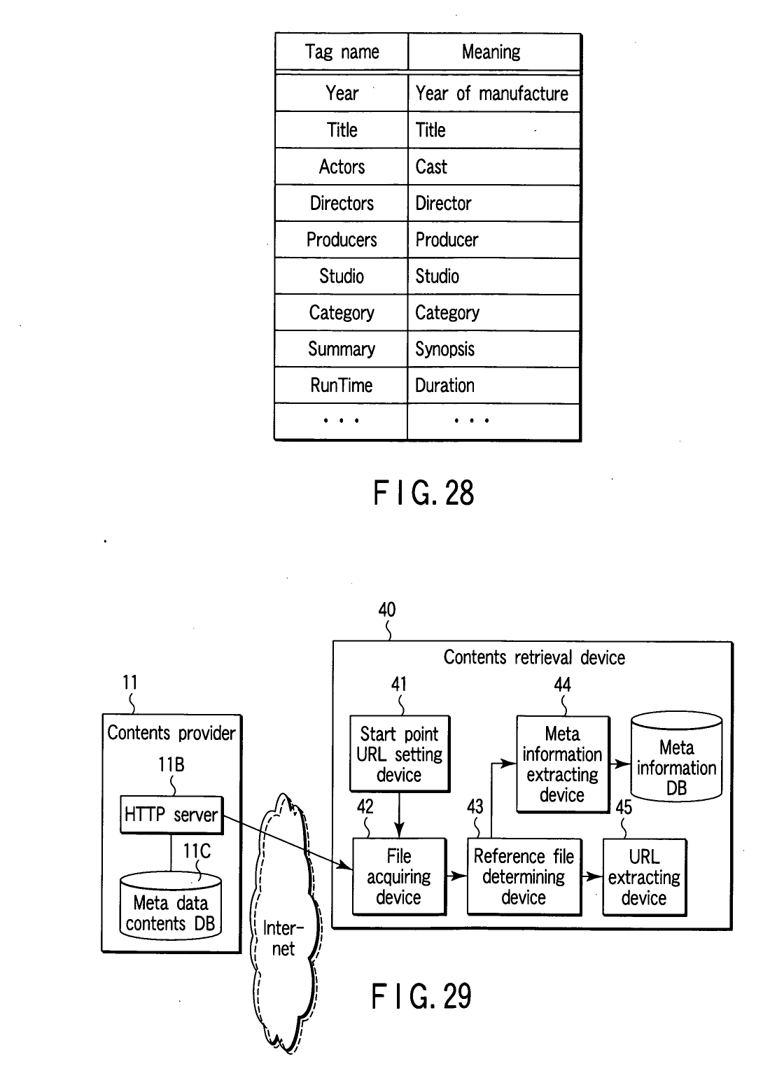

In this contents retrieval function, the reference file of structural format is searched, and the tag is specified as shown in FIG. 28.

A contents retrieval function searches the reference file described by using the tag, and extract meta information from the reference file.

The contents retrieval function mainly includes two functions.

1) Retrieval Function

Function to acquire html document from the Internet site. This includes a start point URL setting device, a file acquiring device, a reference file determining device, and a URL extracting device.

2) Meta Information Extracting Function

Function to extract meta information from the acquired html document. This includes a meta information extracting device and a meta information database (DB)

(Composition of Contents Retrieval Device)

FIG. 29 shows a structure of the contents retrieval device for searching contents, extracting meta information, and storing the meta information.

The contents provider 11 includes an HTTP server 11B, and a meta data contents database 11C. The contents retrieval device 40 includes a start point URL setting device 41, a file acquiring device 42, a reference file determining device 43, a meta information extracting device 44, a URL extracting device 45, and a meta information database (DB).

(Procedure of Retrieval)

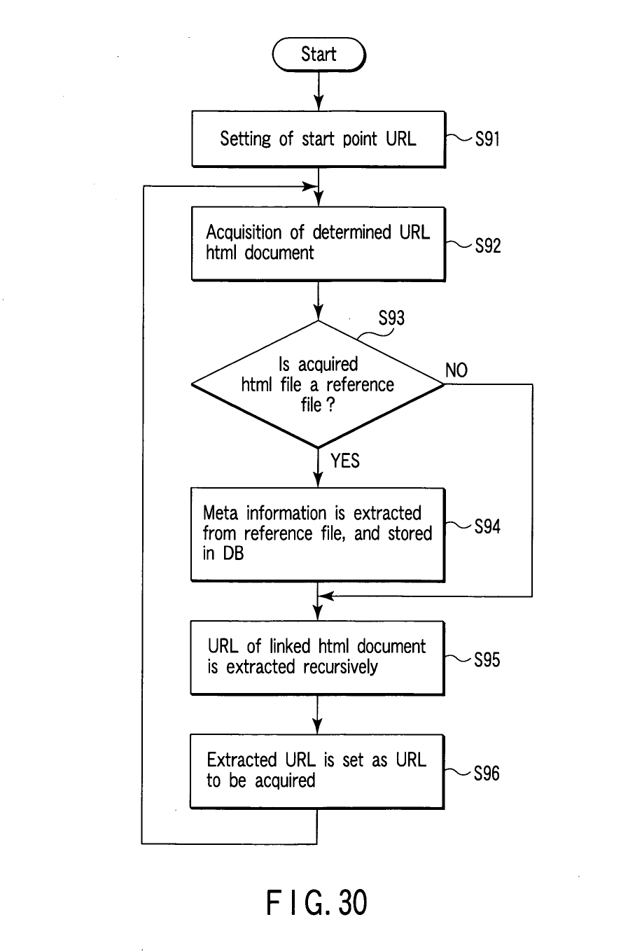

The operation flow by the contents retrieval device is shown in FIG. 30.

In step S91, a start point URL is set in the start point URL setting device 41.

In step S92, an html document of the set URL is acquired by the file acquiring device 42. In a first pass, the html document of the start point URL is acquired, and in second and subsequent passes, the html document of recursively set URL is acquired.

In step S93, the acquired html document is determined to be reference file or not by the reference file determining device 43. If the html document refers to the video contents, this html document is determined to be a reference file.

When the html document is a reference file, in step S94, the meta information extracting device 44 extracts meta information from the reference file, and together with the extracted meta information, the URL in which the contents are present, meta information extraction date, and the like are stored in the meta information database (DB). On the other hand, if the html document is not a reference file, skipping step S94, step S95 is executed.

In step S95, the URL extracting device 45 recursively extract the URL of the html document linked from the acquired html document. Hereinafter, the process from step S92 is repeated.

This contents retrieval process is terminated when reaching one of the following conditions.

When the number of acquired html documents reaches the specified maximum number.

When a specific time has passed since start of retrieval.

The stopping condition must be given beforehand, and after stopping, retrieval can be started again from the first step.

For the sake of efficiency of retrieval, for example, the site providing excellent contents may be set as start point URL, parallel processing may be done by plural retrieval robots, or only a new or changed html document may be acquired.

<Precache Function of Contents>

Precache function of contents is explained below.

(Features of Pre-Cache Method)

To pre-cache the contents from the electronic merchandise distribution apparatus 1 into the head end 2, distribution hub 4, and hard disk in the electronic merchandise receiving terminal 6, by making use of

a) preference information,

b) viewing information, and

c) retrieval information,

the excellence of contents (merit points) is determined, and compared, and the contents are pre-cached in the distribution server installed in the electronic merchandise receiving terminal 6 or distribution hub 4.

In addition, by using contents meta information, the processing system is automated by acquiring contents viewing time (duration), contract data (contract term), etc.

(Preference Information)

In the case of movies, for example, the viewer has either a definite preference of actor, director or genre, or a vague preference (such as preference of old-fashioned style movies). Such vague preference is also categories in definite preference information, and in each preference item (such as actor and genre), preference information (preference points) is held and managed in each viewer.

Preference points are categorized into actors, directors, genre, music, etc. Finally, in each movie, the preference points are summed up, and the excellence of the movie is evaluated. Basic information for preference points is the information inputted by the viewer at the time of contract. Of course, a screen is prepared for subsequent changes to be used by the viewers, and the crude data of preference information can be updated.

First, the viewer inputs the preference or the importance of each preference category by the category of actor, director and genre. This is inputted from the individual screen on the TV. In every preference category, the entry is selected (or specified), and preference points (in the full score of 3 points) should be inputted.

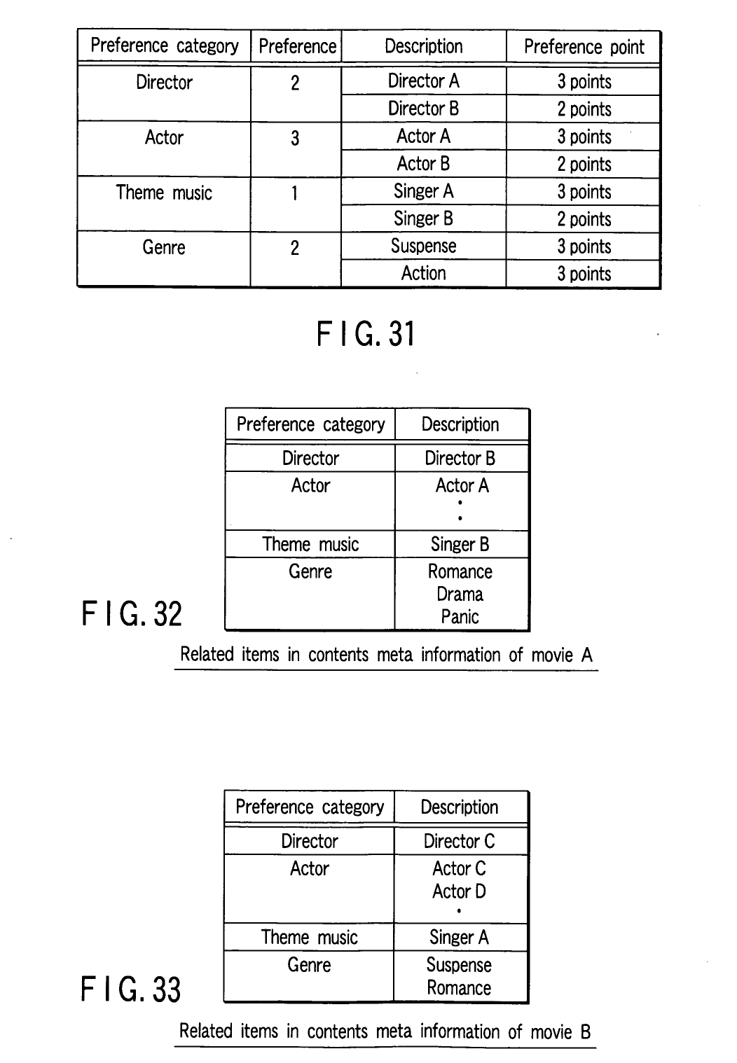

For example, viewer A inputs the preference information as shown in FIG. 31.

For the sake of simplicity, two items are inputted in each category. No input, no score. As entries in each category (for example, J. Cameron in the category of director), principal examples may be presented for selection, or the viewer may specify individually, together with scoring of points.

Categories include date of manufacture, duration, manufacturer, playwright, camera work, music, lyrics, composition, arts CG, producer, etc.

On the basis of preference information of this viewer, preference points of movie A and movie B are calculated. Incidentally, preference information of each category of movie is stored in the contents meta information DB.

Related items of contents meta information of movie A are as shown in FIG. 32, and related items of contents meta information of movie V are as shown in FIG. 33.

In this case, viewer A's preference points of movies are as follows.

MovieA(15points)=directorB(2points)×preference of director(2points)+actorA(3points)×preference of the cast(3points)+singerB(2points)×preference of theme music(1point)

Movie B(9points)=singer A(3points)×preference of theme music(1point)+suspense(3points)×preference of genre(2points)

As a result, by comparison of preference points only, movie A is superior in excellence. By comparing or summing the scored points, the preference points can be calculated in the limited population of the movies.

Preference information is stored as preference information DB. Preference points can be calculated in the contents as far as contents meta information is present, and can be calculated even in a new movie.

(Viewing Information)

Viewing information is, in the case of movies, for example, the number of times of viewing each movie (viewing score). In the case of VOD distribution, for example, it is simply the number of times the movie is seen in a unit period. In the case of VOD viewing, the duration of seeing the movie (stopping in the midst of seeing) can be measured. It is also possible to consider by including the number of times of seeing the preview of the movie. In preview viewing, the number of points may be set lower than in actual viewing.

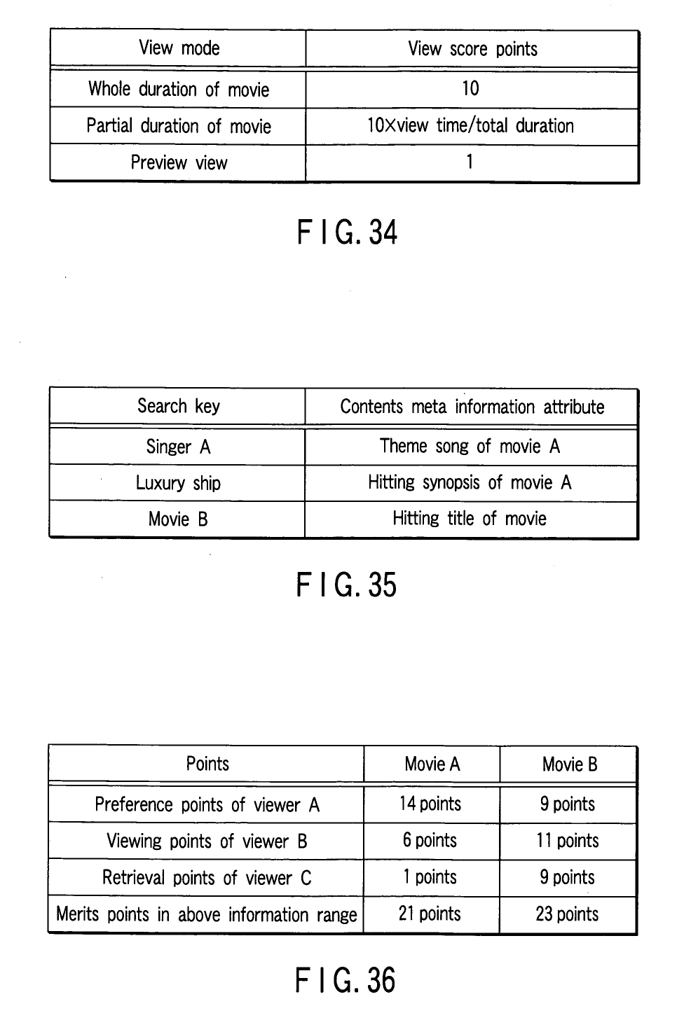

Viewing points are set according to the mode of viewing, for example, as shown in FIG. 34.

For example, when a certain view B sees the preview of movie A, and stops seeing the actual movie halfway (not seeing for the specified duration), and sees the preview of movie B, and sees the actual movie full time, and viewing points are as follows.

MovieA(6points)=seeing halfway(5points)+preview seeing(1point)

MovieB(11points)=seeing full length(10points)+preview seeing(1point)

This viewing information can be summed up with respect to the movies already distributed. However, if summed up for long, the older movie has a higher score, and it is required to calculate anew periodically, for example, once a month.

What matters here is handling of new movies. Since viewing points are not present, the excellence (merit points) of movies cannot be compared merely by the sum of the preference points and viewing points because the new movie is always lower in score. However, viewing points are important index for evaluating the excellence of existing movies, and hence cannot be eliminated. Accordingly, for new movies, promotion points of each new movie are added instead of the viewing points.

(Learning Function by Viewing Information)

After seeing the movie, the viewer is interviewed, and the information can be updated in each preference information category. For example, after viewer A has seen movie B, if 1 point is given to the question about the director, 1 point can be added to director C in the category of director in the preference information of viewer A.

This is a simple example, but as the number of times of viewing the movies increases, if not implicitly as explained above, the preference points may be added. For example, when viewer A sees three movies featuring actor C, actor C common to these categories may be recognized as preference information, and 1 point can be added to actor C as the cast category of preference information of viewer A. The threshold value for the preference information (in this case, 1 point for three appearances) may be variable.

(Retrieval Information (Learning Function by Retrieval Key))

Retrieval information is the information that can be added to the reference points by the retrieval key to be entered by the viewer on the retrieval screen. Specifically, the retrieval key is related with either attribute of the contents meta information by the dedicated dictionary, and it is added as preference point.

For example, when the retrieval key is related to the title or cast of the movie, it is calculated as preference point. Or if a fuzzy retrieval key such as “pleasant movie” is not related to any meta information, it can be related to relative information created by the dictionary (for example, genre of comedy).

For example, when viewer C executes retrieval by the retrieval key as follows, the contents meta information attribute derived from the specified dictionary is as shown in FIG. 35, and the added value to the preference points is as shown in FIG. 36. Of course, the retrieval key hits multiple contents meta information attributes (for example, the keyword of luxury ship hits plural movies), but only one example of contents meta information attribute is given herein for the sake of simplicity.

Therefore, giving one retrieval point for one retrieval deed, by the retrieval deed of viewer C, the retrieval points of movie A and movie B are as follows.

Movie A(1point)=luxury ship(1point)MovieB(2points)=singer A(1point)+movieB(as movie title)(1point)

(Merit Points)

Using the preference information, viewing information and retrieval information explained above, merit points of movie A and movie B are calculated as shown in FIG. 36. Herein, preference points of viewer A, viewing points of viewer B, and retrieval points of viewer C are summed up. Of course, there are preference points in viewer B and viewer C, but these three points are summed up herein in order to show the concept of merit points.

For example, when calculating the merit points in order to find out excellent contents in a certain distribution server, the merit points of the population serviced in the distribution server are summed up.

Merit points of certain contents=preference points(including learning portion)+viewing points+retrieval points(including learning portion)

(Contract Terms Check with Contents Provider)

The electronic merchandise distribution apparatus 1 pre-caches the contents according to merit points into the head end 2 and distribution hub 4 in the system operator 13, electronic merchandise receiving terminal 6, and the like, but actually prior to pre-caching, it is necessary to check if the pre-caching destination is a distribution available region or not, by referring to the distribution area of the contents meta information of the contents contract management server 112.

Depending on the contract between the contents provider and the MSO, there may be no limitation on the number of times of use of contents in a limited period, such as SVOD (subscription VOD). Such contents are handled separately, and merit points are calculated in the SVOD service, and a recommended distribution contents list is compiled.

(Contract Terms Check with System Operator)

The electronic merchandise distribution apparatus 1 provides contents to the system operator in various formats, such as SVOD, service collecting premium contents (premium service), and the like.

For example, the electronic merchandise distribution apparatus 1, if permitted by the contract with the contents provider, can compose premium service by collecting excellent contents only according to the results of merit points calculated above, or can provide contents to the system operator at an extra charge.

As for the SVOD, different charges can be set for individual VOD services.

The electronic merchandise distribution apparatus 1, prior to pre-caching to the system operator, checks the service subscription contract in each system operator by referring to the contents contract management server 112, and executes pre-caching.

(Algorithm in Each Pre-Cache Site)

In pre-cache, the algorithm differs in each site. Precache sites are, in the case of CATV system, for example, three positions, that is, the electronic merchandise receiving terminal, distribution hub cache, and head end cache.

(Caching in Electronic Merchandise Receiving Terminal)

Caching in the HDD 305 built in the electronic merchandise receiving terminal 6 is the summation of preference points, viewing points and retrieval points of members (usually family) using this electronic merchandise receiving terminal. The summed value is pre-cached as merit points of each movie sequentially from higher points.

In certain cases, since movies and SVOD cannot be viewed unless the viewer is subscribed in special services, contract conditions are checked by the viewer management server before pre-caching.

(Caching in Distribution Hub)

In caching in the distribution server installed in the distribution hub 4, contents to be viewed at high possibility (excellent contents) are pre-cached. As a result, the circuit load at the backbone side is lowered, and cases of service incapability due to its bottleneck are decreased.

For calculation of excellence of contents, in the population of viewers distributed from the distribution server installed in the distribution hub, preference points, viewing points and retrieval points are summed up as merit points of contents, and contents are pre-cached in the sequence of higher merit points.

(Caching in Head End)

It is a first requirement for the head end 2 to have contents not cached in the electronic merchandise receiving terminal or distribution hub 4.

Referring again to FIG. 1, suppose plural distribution hubs 4 are connected to the head end 2. For the sake of simplicity, suppose two distribution hubs 4 have contents D, E, F and G.

In the algorithm described above, suppose contents D, E are pre-cached in the first distribution hub (A), and contents D, F in the second distribution hub (B). At this time, the algorithm of caching in the distribution server of the head end is as follows.

1) First, the head end regards contents G not cached in the distribution hubs (A) and (B) as the highest priority.

2) Next priority goes to contents F not cached in the distribution hub (A), and contents E not cached in the distribution hub (B). The priority ranking of E and F depends on the calculation of merit points by the viewers.

3) Finally, contents D are cached.

(Precache Timing)

When a new movie arrives, immediately before start of its distribution, merit points are measured in each content, from the cached contents of lower merit points, merit points of new movies and merit points of cached contents are compared, and new movies of higher merit points substitute sequentially.

(Precache Flow)

The algorithm of entire system including the electronic merchandise distribution apparatus 1 is considered.

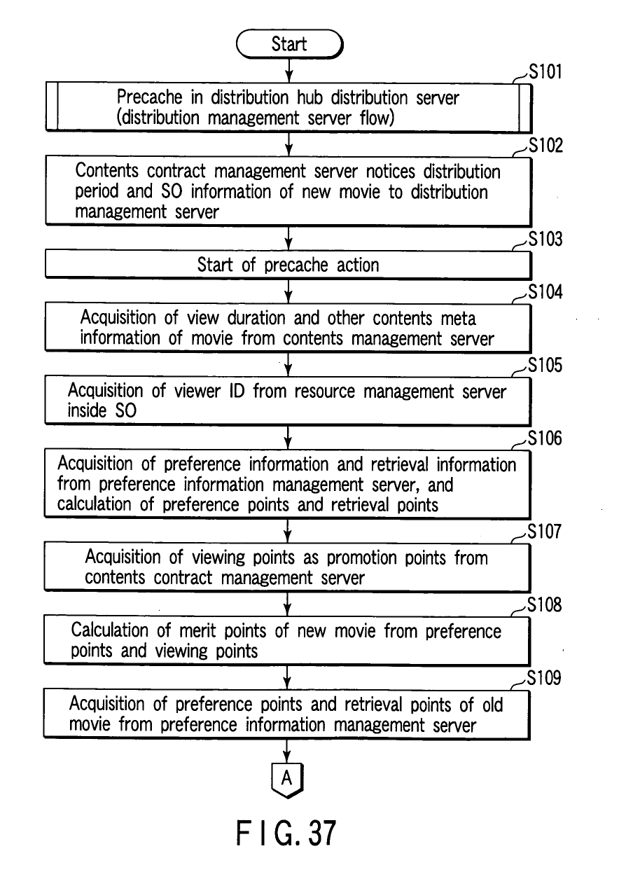

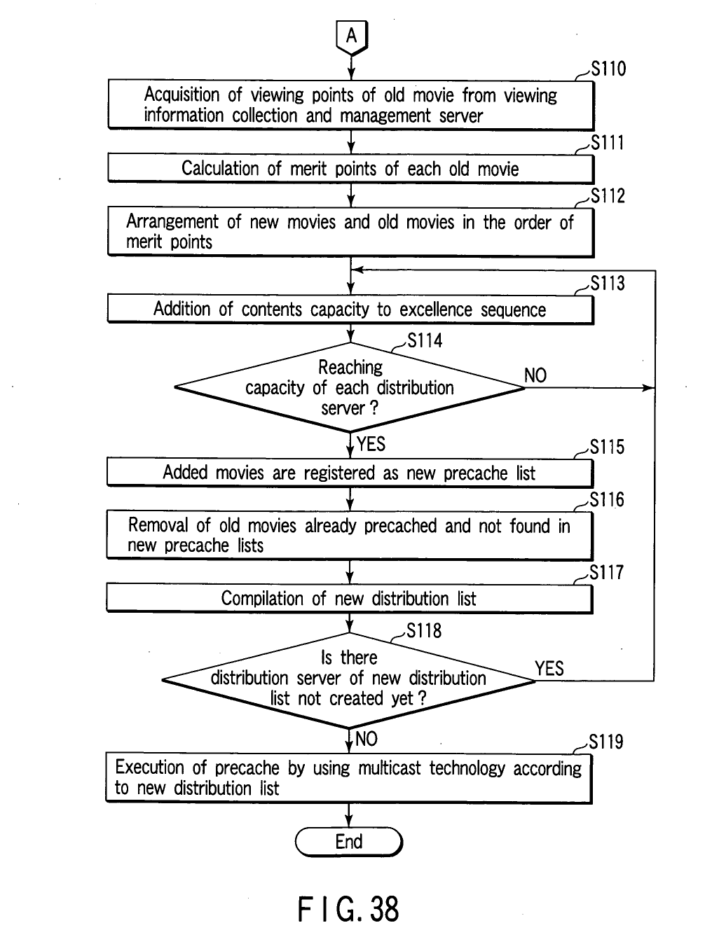

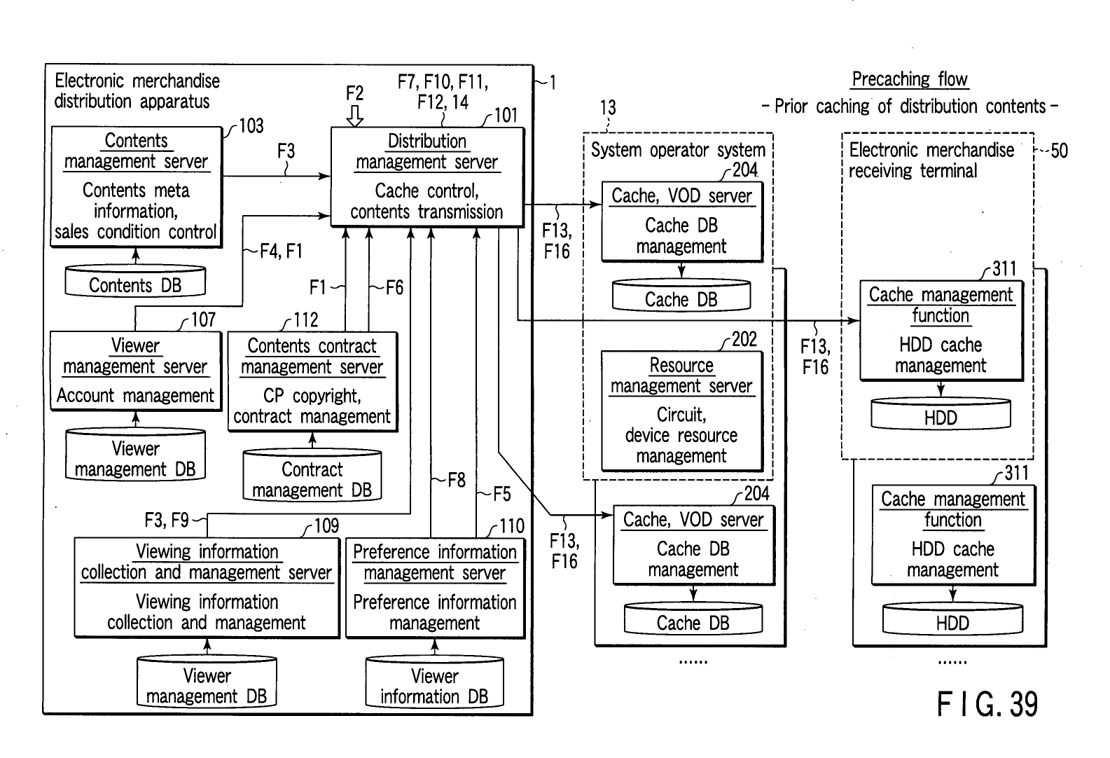

Herein, a case of pre-caching in the distribution server 10 installed in the distribution hub 4 is explained by referring to FIGS. 37 to 39.

Assuming pre-cache flow of contents usable in general VOD service, SVOD and premium service are not taken into consideration. Therefore, the contract condition check of system operation is not executed.

In step S101, the distribution management server 101 starts pre-caching into the distribution server 10 installed in the distribution hub 4.

In step S102, as preparatory step, the contents contract management server 112 notices the ID of new movie, distribution period on the basis of contract with the contents provider 11, distribution enabled system operator information and the like to the distribution management server 101. (F1)

In step S103, the distribution management server 101 (in charge of management of date and pre-cache timing) kicks off the operation of pre-cache. (F2)

In step S104, the distribution management server 101 acquires contents meta information including the capacity from the contents management server, and compiles into DB. (F3)

In step S105, the viewer ID is inquired to the viewer management server 107 and obtained in order to specify the viewer serviced by the corresponding distribution server. (F4)

In step S106, the distribution management server 101 acquires preference information (including retrieval information) from the preference information management server 110, and calculates preference points and retrieval points of each new movie. (F5)

In step S107, the distribution management server 101 acquires viewing points as promotion points of new movie from the contents contract management server 112. (F6)

In step S108, summing up the points acquired in steps F5 and F6, merit points of all new movies are calculated, and referring to the distribution region of each new movie obtained in step F1, those not distributed in the service regions of the distribution server 10 of the distribution hub 4 executing these pre-caches are eliminated, and merit points of new movies to be distributed in the corresponding distribution server 10 are determined. (F7)

In step S109, the distribution management server 101 acquires merit points of existing movies already distributed (old movies). These points are always calculated in the preference information management server 110 and viewer information collection and management server 112, and they are obtained. First, the distribution management server 101 inquires the preference points and retrieval points of old movies to the preference information management server 110. (F8)

In step S110, viewing points of old movies are inquired to the viewing information collection and management server 109, and acquired. (F9)

In step S111, the distribution management server 101 sums up the preference points, viewing points and retrieval points obtained in steps F9 and F10, and calculates the merit points of each old movie. (F10)

In step S112, the distribution management server 101 arranges old and new movies in the sequence of excellent on the basis of merit points of old movies calculated in step F11 and merit points of new movies calculated in step F8. (F11)

In steps S113 to S115, the distribution management server 101 adds the capacities in the sequence of excellence created in step F11 until reaching the capacity of the pre-cache using region of the corresponding distribution server 10. (F12)

In step S116, the distribution management server 101 creates a pre-cached list of old movies from the new pre-cache list created in step F12, and distributes the differential information from the current pre-cached lists to the distribution server. The distribution server 10 erases the contents according to the differential information. (F13)

In step S117, the distribution management server 101 compiles a new distribution list from the contents of new movies to be pre-cached newly and contents of old movies not pre-cached at the present, from the new pre-cache lists. (F14)

In step S118, processes of F7 to F14 are executed on the distribution servers 10 installed in all distribution hubs, and the contents distribution information is created for each distribution server. (F15)

In step S119, contents are pre-cached in all distribution servers (including cache VOD server 204 in the system operator 13, and cache management function 311 in the electronic merchandise receiving device 50). At this time, multicast technology can be employed as for the common movies to be pre-cached in each distribution server 10. (F16)

(Hardware of Electronic Merchandise Receiving Terminal)

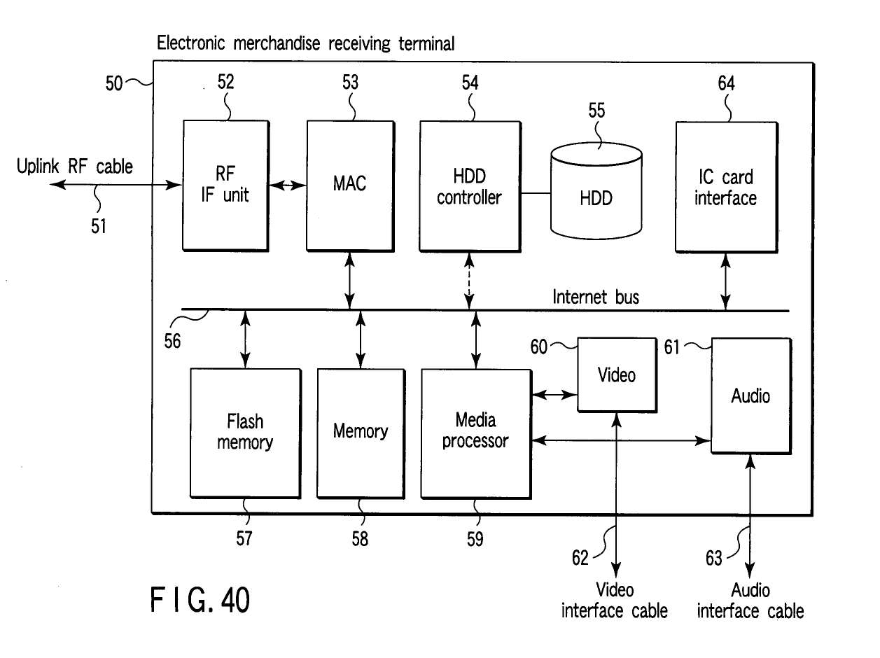

For reference, an example of hardware of the electronic merchandise receiving terminal 50 installed at the house of the subscriber is shown in FIG. 40. Various functions explained above are installed in this hardware.

This is shown as a set top box connected to the cable network, but other examples include the set top box connected to the Ethernet, and boxes connected to the ADSL, FTTH, and other interfaces.

An RF cable 51 is for connecting between the electronic merchandise receiving terminal 50 and the household COAX interface.

An RF tuner 52 is for modulating digital signals in both uplink and downlink direction in to the RF service frequency band of COAX.

A MAC interface 53 is a MAC interface IC for terminating the CableMAC protocol in this case.

An HDD controller 54 is for data transfer between the HDD and memory.

An HDD 55 is used for purpose of temporary storage of storing regions and contents of various middleware programs, players, CODEC programs, etc.

An internal bus 56 is used for mutual connection of communication IC, various memories, media processors, etc.

A flash memory 57 usually holds a boot program.

A memory 58 is used in transmission and reception of IP packet, execution of execution program, etc.

A media processor 59 is for execution of the OS or middleware, execution of expansion of video using CODEC, etc.

A video (NTSC) encoder-decoder IC 60 is usually an interface such as ITU-656, and is connected to the media processor.

A video interface cable 61 is usually composite interface or S-video interface, and is connected to the TV.

An audio encoder-decoder IC 62 is usually an interface such as IIS, and is connected to the media processor.

An audio interface cable 63 is usually connected to the TV as composite interface.

An IC card interface 64 corresponds to an IC card controller or IC card holder. The controller is for transferring data between the IC card and the memory.

The flow of player, presented service, and service price in the embodiment is described below.

<Flow of Capital Among Service Entities>

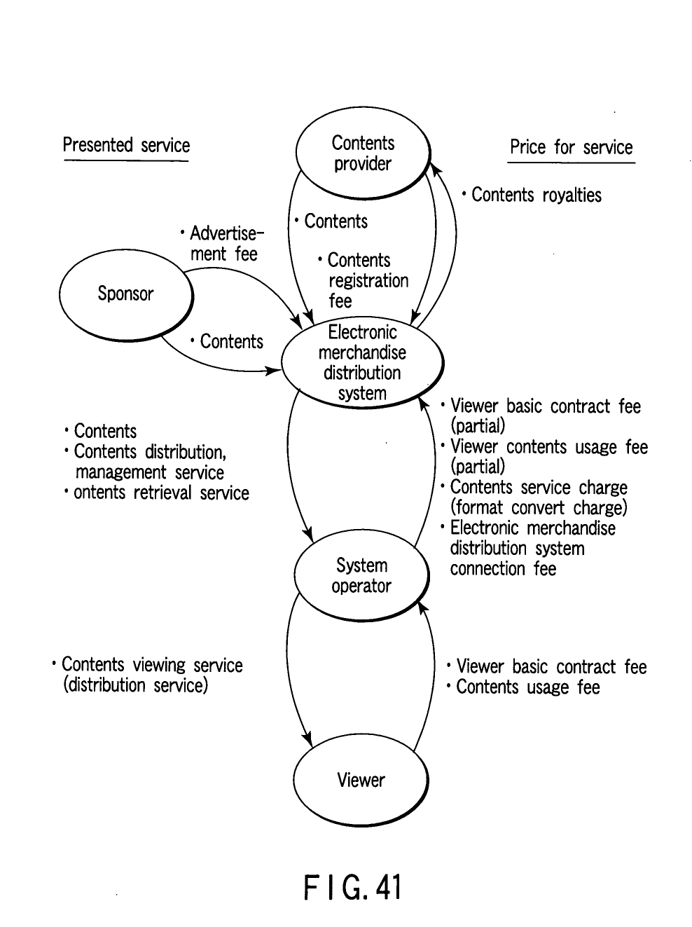

FIG. 41 shows a flow of player, presented service, and service price in the embodiment.

(Contents Provider)

The contents provider receives a part of the price of presenting contents to the electronic merchandise distribution apparatus as a royalty every time the subscriber (hereinafter the viewer) uses the contents provided by the electronic merchandise distribution apparatus. Between certain contents providers and the electronic merchandise distribution apparatus, it is sometimes a trade custom to predetermine the minimum times of use (number of times of viewing) of contents and receive the amount of the royalties multiplied by the minimum times of use as the minimum guarantee (MG).

The electronic merchandise distribution apparatus, in order to sell the contents efficiently, may present the contents including the preference of individual subscribers to the viewers through the TV sales screen of electronic merchandise guide, and make the contents provider to pay the price for using this electronic merchandise guide system. (Contents registration fee)

The contents provider includes a sponsor in its wider sense of meaning (who sends advertising contents to the electronic merchandise distribution apparatus, and pays the contents registration fee, that is, the advertisement fee). In this embodiment, the mechanism relating to such business entity is not described in detail, but for the sponsor, the application examples include presentation of advertising channels linked to the preference information, feedback of preference information, link to the online sales site, and building of online sales site in the electronic merchandise distribution apparatus.

(Electronic Merchandise Distribution Apparatus)

The electronic merchandise distribution apparatus receives a part of contents usage fee of the viewers from the system operator. (Part of contents usage fee)

As the price for using the electronic merchandise guide for each viewer, the amount depending on the number of viewers, that is, part of basic contract fee of the system operator is received. (Part of viewer basic contract fee)

The electronic merchandise distribution apparatus receives the contents processing fee for providing the contents to the system operator (contents service fee), and service charge of the network fee for connecting the electronic merchandise distribution apparatus and the system operator (electronic merchandise distribution apparatus connection charge) from the system operator. (Contents service fee)

The electronic merchandise distribution apparatus receives the contents registration fee explained above from the contents provider. (Contents registration fee)

(System Operator)

The system operator supplies the above services to the subscribers, and receives the basic contract fee and contents usage fee from the subscribers. The contents usage fee is varied, such as the fixed contents usage fee in the SVOD format for allowing to see all contents possessed by the contents provider at a fixed fee, and the VOD in a narrow sense of meaning for charging on every view, but they are not distinguished herein, but are merely handled as contents usage fee.

Types of contents will be described below.

<Classification of Contents>

Types of contents handled in the distribution network of the embodiment are defined as follows.

Contents viewed in the electronic merchandise receiving apparatus are classified into authorized contents and nonauthorized contents. Authorized contents are contents of which distribution between the electronic merchandise distribution apparatus and the contents provider is contracted, and are hence authorized by the electronic merchandise distribution apparatus. On the other hand, nonauthorized contents have no contract relation between the electronic merchandise distribution apparatus and the contents provider.

Nonauthorized contents bring no direct revenue to the electronic merchandise distribution apparatus, and are regarded as services for expanding the attracting points of the services of the embodiment, but when the services are spread, the communication packet for the corresponding service may be recognized between the electronic merchandise distribution apparatus and the Internet when viewing nonauthorized contents, and a meter rate system may be introduced.

Six types of contents are specifically defined below.

1) Authorized Contents A

These are contents authorized by the electronic merchandise distribution apparatus on the basis of the contract between the contents provider and the electronic merchandise distribution apparatus. Basically, these contents are principal contents provided by the electronic merchandise distribution apparatus. In the case of authorized contents A, contents meta information is registered in the electronic merchandise distribution apparatus, and contents transformed in format for distribution (hereinafter called real contents) are also placed in the electronic merchandise distribution apparatus. (Precache is separate.)

2) Authorized Contents B

These are contents authorized by the electronic merchandise distribution apparatus on the basis of the contract between the contents provider and the electronic merchandise distribution apparatus. Contents meta information is registered in the electronic merchandise distribution apparatus, but real contents are at the contents provider side, which is connected to the electronic merchandise distribution apparatus by network or exclusive circuit. If the band of the contents provider and electronic merchandise distribution apparatus is not enough, the pre-cache function of the electronic merchandise distribution apparatus can be utilized.

3) Authorized Contents C

These are contents authorized by the electronic merchandise distribution apparatus on the basis of the contract between the contents provider and electronic merchandise distribution apparatus. Contents meta information is registered in the electronic merchandise distribution apparatus, but real contents are under the control of the contents provider, and placed on the Internet.

This case is realized mainly by assuming the Internet site which is presently providing streaming service to the PC, and such contents provider is supposed to distribute the contents by using the distribution network of the embodiment. For distribution, if the distribution quality on the Internet is guaranteed, it cooperates with the QoS assuring function of the electronic merchandise distribution apparatus. If not guaranteed, the entire contents are downloaded in the electronic merchandise distribution apparatus, or the distribution quality is assured by using the pre-cache function of the electronic merchandise distribution apparatus.

4) Individual Broadcasting Station Contents

These are contents uploaded by the user of electronic merchandise distribution apparatus on the electronic merchandise distribution apparatus by using the individual broadcasting station service, and distributed. The contents meta information is registered in the electronic merchandise distribution apparatus. In this case, the electronic merchandise distribution apparatus functions as the hosting service of the contents.

5) Nonauthorized contents A

These are contents on the Internet detected by a retrieval engine of the electronic merchandise distribution apparatus. The retrieval engine always continues to search on the Internet. The retrieval engine automatically creates meta information from the peripheral information of the HTML file describing the discovered file name or the like, and registers in the electronic merchandise distribution apparatus.

6) Nonauthorized Contents B

By disclosing the meta information, format of guide screen, communication protocol specification, and the like, the contents conforming to the specification are distributed by the contents provider to the electronic merchandise distribution apparatus. Meta information to be viewed (searched) by the user can be registered as nonauthorized contents by application to the electronic merchandise distribution apparatus.

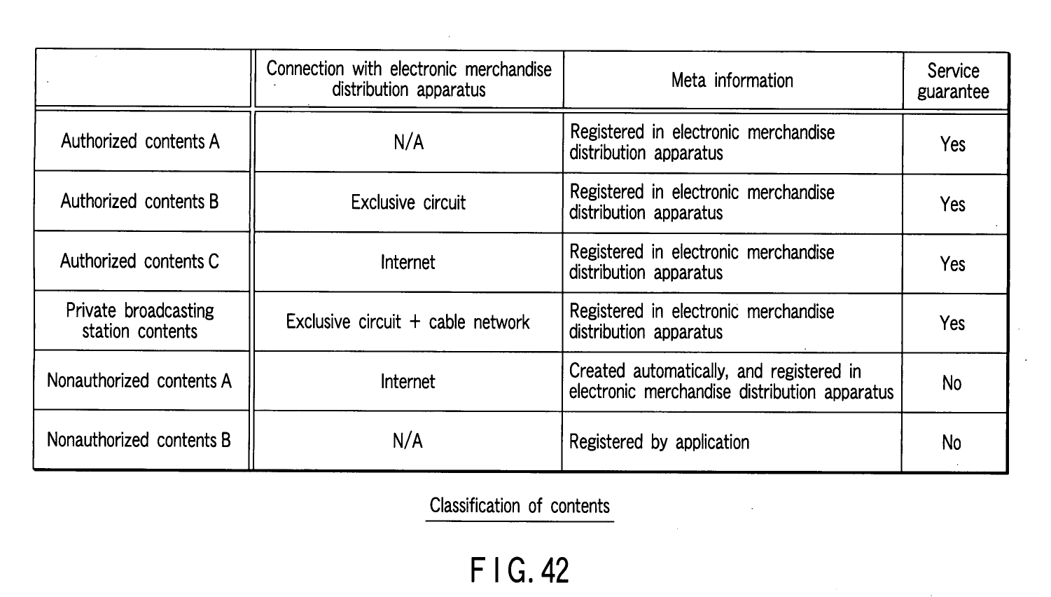

These types of contents are summarized in FIG. 42.

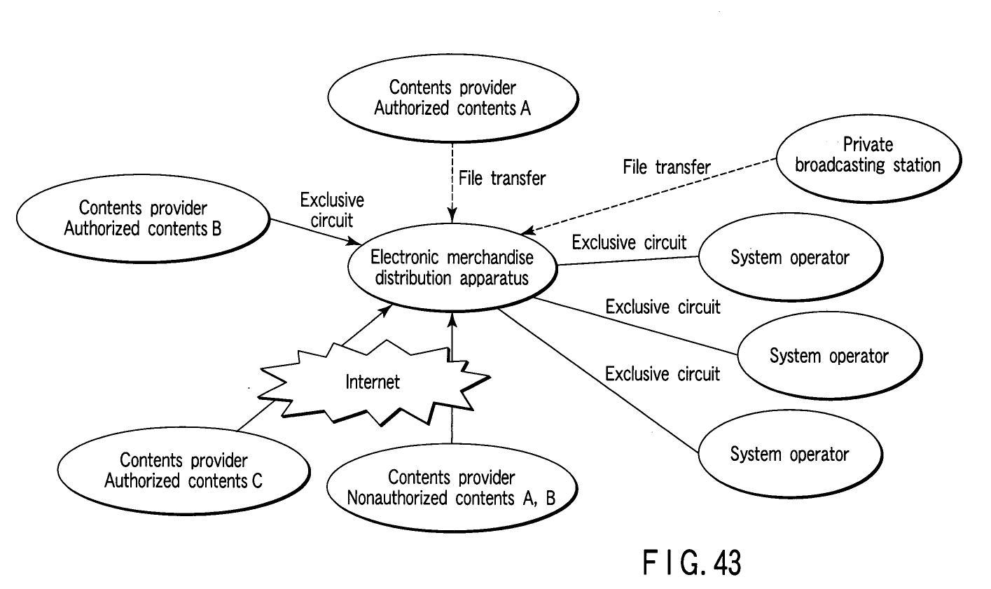

The connection format of the contents provider having these contents and the electronic merchandise distribution apparatus is shown in FIG. 43.

<Method of Acquiring Contents>

Concerning video contents, in particular, the contents provider having authorized contents and presented contents are explained.

1) Movie Manufacturing Company, Etc.

Movie contents acquired from the movie manufacturing company, movie copyright owner, and moving distribution house are principal contents to be distributed in the service of the embodiment. The electronic merchandise distribution apparatus acquires master contents, contents meta information, or information for creating contents meta information.

2) Contents Aggregator

Contents aggregator, in most cases, receives a permit for use from the contents copyright owner, and distributes contents of DVB specification (MPEG2, MPEG2-TS) to the system operators.

To handle these contents as authorized contents A, the real contents (usually MPEG2 compressed contents) and meta information are placed in the electronic merchandise distribution apparatus.

To acquire contents from such contents aggregator, and to distribute the contents, the permission of the contents provider existing at the destination of the aggregator is required in one case, and not required in other case.

3) Television Station

There are contents providers having TV program contents and copyright, such as television station, television program production firm, etc. In this case, too, same as other contents providers, the electronic merchandise distribution apparatus acquires master contents and information for creating meta information.

4) Internet Streaming Site

The streaming site operator for PC distributes contents by using the distribution network of the electronic merchandise receiving apparatus. Meta information and the like must be also registered by the contents provider in the electronic merchandise distribution apparatus. In this case, if the pre-cache function is used, the contents must be once transferred to the distribution server in the electronic merchandise distribution apparatus. If the pre-cache function is not used, it is also possible to distribute directly from the streaming site.

<Flow of Contents Distribution>

On the basis of the contract with the electronic merchandise distribution apparatus, these are contents permitted to be distributed within the distribution network of the electronic merchandise receiving apparatus. Contents meta information is registered in the electronic merchandise distribution apparatus. Outline of flow between the contents provider and electronic merchandise distribution apparatus by each type of contents is explained below.

(Flow Up to Distribution of Authorized Contents)

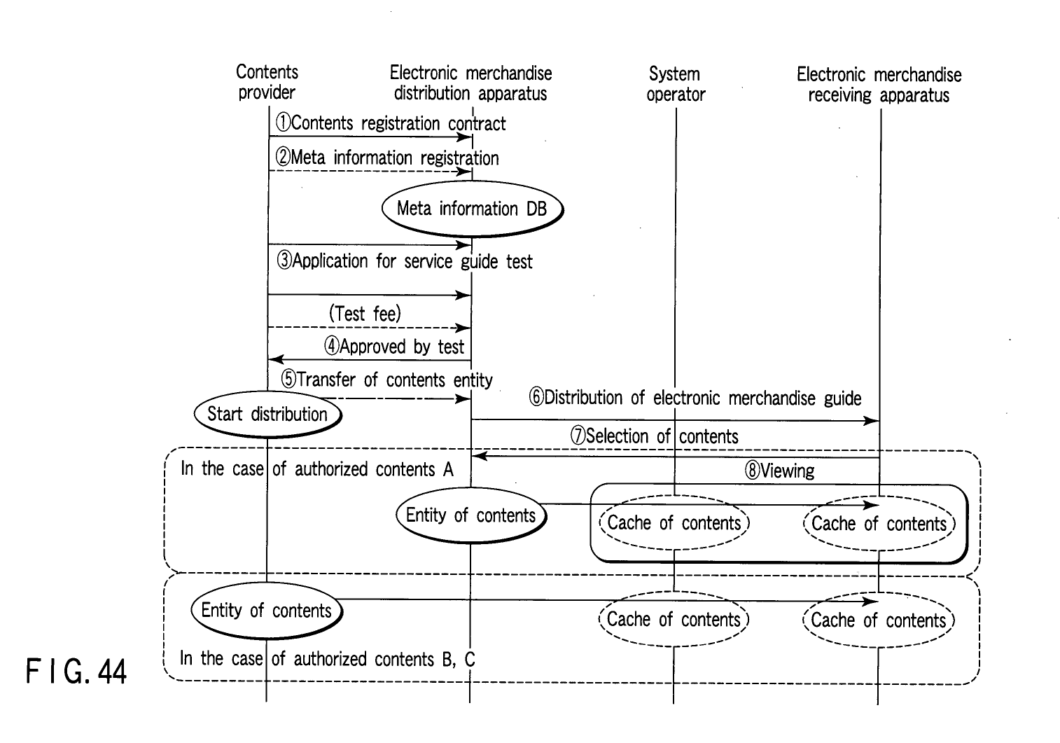

The flow of distributing authorized contents will be explained by referring to FIG. 44.

(1) Registration contract is agreed between the contents provider and the electronic merchandise distribution apparatus.

(2) The electronic merchandise distribution apparatus acquires the meta information of the corresponding contents, and registers in the contents meta information DB. At this time, creation of meta information may be consigned to the electronic merchandise distribution apparatus.

(3) In the contents provider, when accessing to the set of own contents as a result of retrieval of the electronic merchandise distribution apparatus, a service guide screen is displayed as its guidance screen. In actual service, it may be considered to test at a due charge to see if the service guide screen conforms to the format of the embodiment. Application for test is the process at this step.

(4) The test result is returned to the contents provider.

(5) The contents provider transfers the entity of contents to the electronic merchandise distribution apparatus in the case of contract of authorized contents A. In the distribution active period, the electronic merchandise distribution apparatus measures merit points of contents, and pre-caches the contents at optimum pre-cache position.

(6) The contents provider creates electronic merchandise guide including the newly registered contents, and distributes to the subscribers having the electronic merchandise receiving apparatus.

(7) The subscriber selects contents from the electronic merchandise guide.

(8) The electronic merchandise distribution apparatus executes distribution of contents from the optimum position. In the case of authorized contents B or C, since the contents are present in the contents provider, if the QoS is assured between the contents provider and electronic merchandise distribution apparatus, contents can be distributed directly from the contents provider, and otherwise the pre-cache is used in distribution.

(Service Guide Screen and its Test)

Service guide is a first screen of service in service format of grouping plural contents and distributing VOD to the viewers within the group range, and it is a screen for navigating to an actual contents sales screen. The format of charging in the unit of such grouped contents is called the SVOD (subscription VOD).

This service guide screen is created by referring to the contents meta information and contents server controlled in the contents management server by the electronic merchandise distribution apparatus or others, and the period of creating or changing basically depends on the will of the contents provider.

The contents provider may consign the design of the guide screen to the electronic merchandise distribution apparatus or the like, but can also set by itself by conforming to the specification presented by the electronic merchandise distribution apparatus. In the case of own manufacture of guide screen, the contents provider sends the guide screen and its meta information to the electronic merchandise distribution apparatus to have tested to see if conforming to the specification of the electronic merchandise distribution apparatus, and when approved, the electronic merchandise distribution apparatus approves by electronic watermarking or entry into meta information.

Testing at the electronic merchandise distribution apparatus covers widely from the technical aspects such as display and necessary function (link to the contents sales screen), and inside aspects conforming to public order and morals.

Testing of the guide screen created by the contents provider may be charged if necessary.

(Flow of Distribution of Nonauthorized Contents)

Nonauthorized contents are contents having no contract relation about distribution between the electronic merchandise distribution apparatus and the contents provider.

In this case, distribution is not guaranteed, and the user basically views by the own responsibility.

1) Distribution Flow of Nonauthorized Contents A

In nonauthorized contents A, if the contents provider is not particularly conscious about the electronic merchandise distribution apparatus, this service provides the subscriber of the electronic merchandise distribution apparatus with the contents retrieval means.

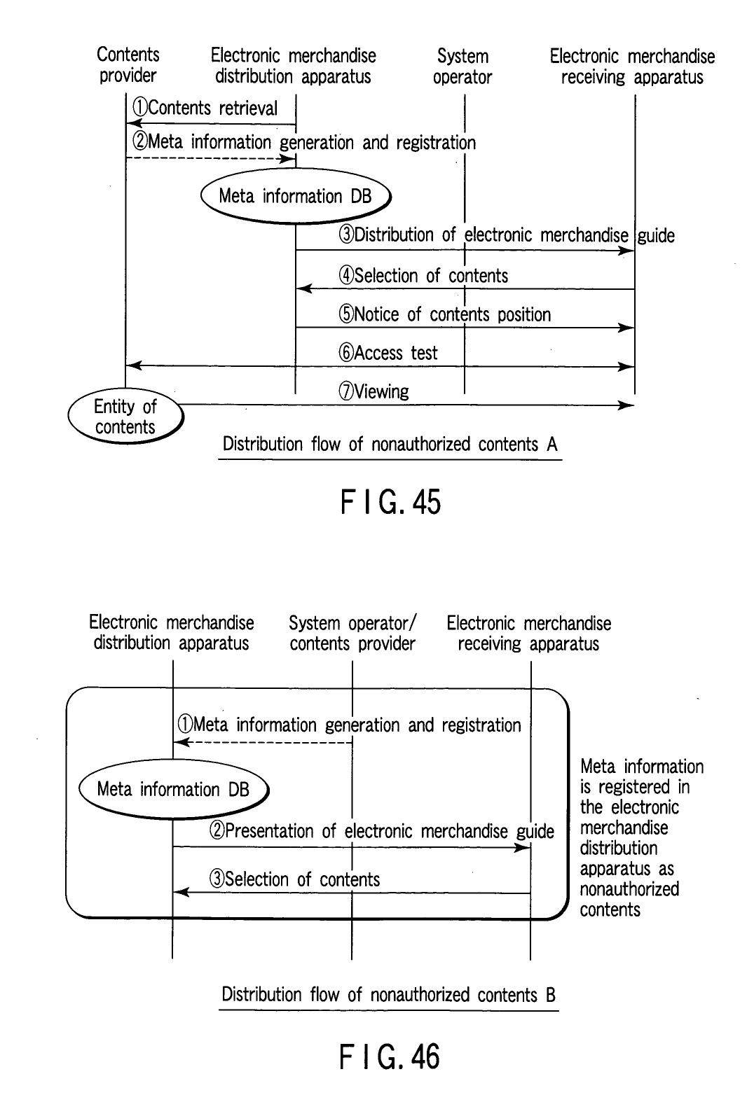

Referring to FIG. 45, the distribution flow of nonauthorized contents A is explained.

(1) The electronic merchandise distribution apparatus searches contents existing on the Internet.

(2) When contents are present, the electronic merchandise distribution apparatus creates contents meta information from its HTML peripheral information.

(3) The electronic merchandise distribution apparatus presents the electronic merchandise guide including the nonauthorized contents A to the subscriber as the contents retrieval result.

(4) The subscriber selects nonauthorized contents A.

(5) The electronic merchandise distribution apparatus informs the electronic merchandise receiving apparatus of the contents location.

(6) The electronic merchandise receiving apparatus measures the current circuit rate by using the access test function (described below) for the contents provider.

(7) On the basis of the access result, the subscriber determines viewing, and views.

(Access Test Function)

Access test function is to measure the available circuit rate between the subscriber and the contents distribution point when contents of which QoS cannot be guaranteed are present on the Internet. For measuring the circuit rate, various methods may be considered, such as measurement of reception rate in the buffering portion of the first part of the real contents at the electronic merchandise receiving apparatus side, and measurement of average reception rate by distributing the test file before the contents provider distributes real contents.

Besides, since the QoS is guaranteed from the electronic merchandise distribution apparatus to the electronic merchandise receiving apparatus, this access test function may be a function between the electronic merchandise distribution apparatus and the contents provider.

2) Distribution Flow of Nonauthorized Contents B

In nonauthorized contents B, the contents provider is assumed to be conscious of the electronic merchandise distribution apparatus specification, and register the meta information in the electronic merchandise distribution apparatus, and create the service guide screen conforming to the use of the electronic merchandise distribution apparatus.

In the following example, the system operator is supposed to distribute the own contents by using the electronic merchandise distribution apparatus.

The flow of distributing nonauthorized contents B will be explained by referring to FIG. 46.

(1) The system operator creates meta information, and registers in the electronic merchandise distribution apparatus (or it may be consigned to the electronic merchandise distribution apparatus).

(2) The electronic merchandise distribution apparatus presents the electronic merchandise guide including the nonauthorized contents A registered in (1) to the subscribers.

(3) The subscriber selects contents.

(Individual Broadcasting Station Contents)

Individual broadcasting station contents are contents transmitted by the user of the electronic merchandise receiving terminal 50. Contents meta information is registered in the electronic merchandise distribution apparatus.

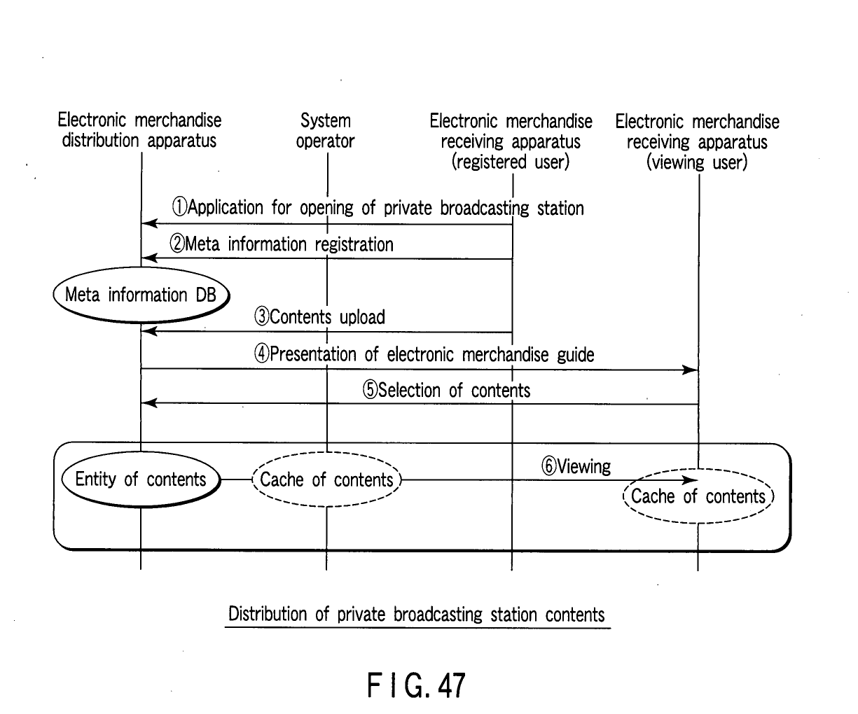

The flow of distributing individual broadcasting station contents will be explained by referring to FIG. 47.

(1) A user wishing to open an individual broadcasting station files an application to the electronic merchandise distribution apparatus, and makes a contract.

(2) Meta information of individual broadcasting station contents is registered in the electronic merchandise distribution apparatus.

(3) Distribution contents are uploaded.

(4) The electronic merchandise distribution apparatus presents the electronic merchandise guide together with individual broadcasting station contents mainly as the result of retrieval.

(5) The subscriber (viewing user of the electronic merchandise receiving apparatus) selects individual broadcasting station contents.

(6) The electronic merchandise distribution apparatus executes distribution of contents from an optimum position.

(Service Guarantee of Authorized Contents C)

Since authorized contents C are distributed from the Internet, the distribution quality cannot be guaranteed unless the Internet infrastructure for connecting the contents provider is enough. This problem can be solved by the following measures.

1) If necessary band cannot be acquired when viewing the contents, contents are downloaded in the electronic merchandise receiving apparatus, and viewed.

2) As variable bit rate service, the bit rate of contents is changed dynamically conforming to the occupied band.

3) A view period (for example, 1 week) is set to allow viewing for this period.

4) A complete viewing is detected, and it is charged only in this case (or viewing of about half of contents).

Mainly, the case 1) is a general service mode, and by applying the method of pre-cache described below, download of contents is executed.

The relation between the electronic merchandise distribution apparatus and the system operator is described below.

<Relation Between Electronic Merchandise Distribution Apparatus and System Operator>

As shown in FIG. 1, plural access providers (system operators) can be connected to one electronic merchandise distribution apparatus, but the function of the electronic merchandise distribution apparatus in the embodiment can be incorporated inside each system operator in the transition period of its system configuration.

The contents may differ in the distribution district or distribution period depending on the contract with the contents provider. Therefore, the electronic merchandise distribution apparatus pre-caches in the distribution server in the system operator in consideration of such information. When the electronic merchandise distribution apparatus presents the contents list to the viewer as the retrieval result, even if the same retrieval keyword is used, the retrieval result may be different depending on the distribution district.

<Plurality of Electronic Merchandise Distribution Apparatuses>

The electronic merchandise distribution apparatus presents services to multiple system operators, but when the number of subscribers receiving services of electronic merchandise guide from the electronic merchandise distribution apparatus increases, it may be required to have a plurality of electronic merchandise distribution apparatuses from the viewpoint of distribution of load. Or, when presenting services to system operators located in remote places geometrically, it is required to install an electronic merchandise distribution apparatus in each district to avoid soaring circuit expenses for connecting the electronic merchandise distribution apparatus and system operator.

In such a case, in order to set up an electronic merchandise distribution apparatus, an extra electronic merchandise distribution apparatus is erected by licensing the architecture of the embodiment. However, it is basically banned for the system operator to receive services from plural electronic merchandise distribution apparatuses, and it is allowed to receive contents services from other electronic merchandise distribution apparatus in a different type of contents (for example, movies and games).

In the same contents field, it is required to control the territory between the electronic merchandise distribution apparatuses. At this time, when receiving a service newly from an electronic merchandise distribution apparatus for a certain system operator, which electronic merchandise distribution apparatus to select basically depends on free competition among the electronic merchandise distribution apparatuses, but an organization for supervising the management of entire electronic merchandise distribution apparatuses may be also considered.

<Plurality of Electronic Merchandise Distribution Apparatuses and Contents>

If a plurality of electronic merchandise distribution apparatuses are present, basically, acquisition of contents from contents providers should be executed by an organization for supervising the entire electronic merchandise distribution apparatuses, but it can be also executed by the own decision of the individual electronic merchandise distribution apparatus. Herein, in the phase of existence of a plurality of electronic merchandise distribution apparatuses, the contents acquisition flow is explained below.

(Case of Acquisition of Contents by Supervising Organization of Electronic Merchandise Distribution Apparatuses)

In this case, the supervising organization of electronic merchandise distribution apparatuses contracts with the contents provider as the representative of all electronic merchandise distribution apparatuses, and registers the acquired contents in all electronic merchandise distribution apparatuses.

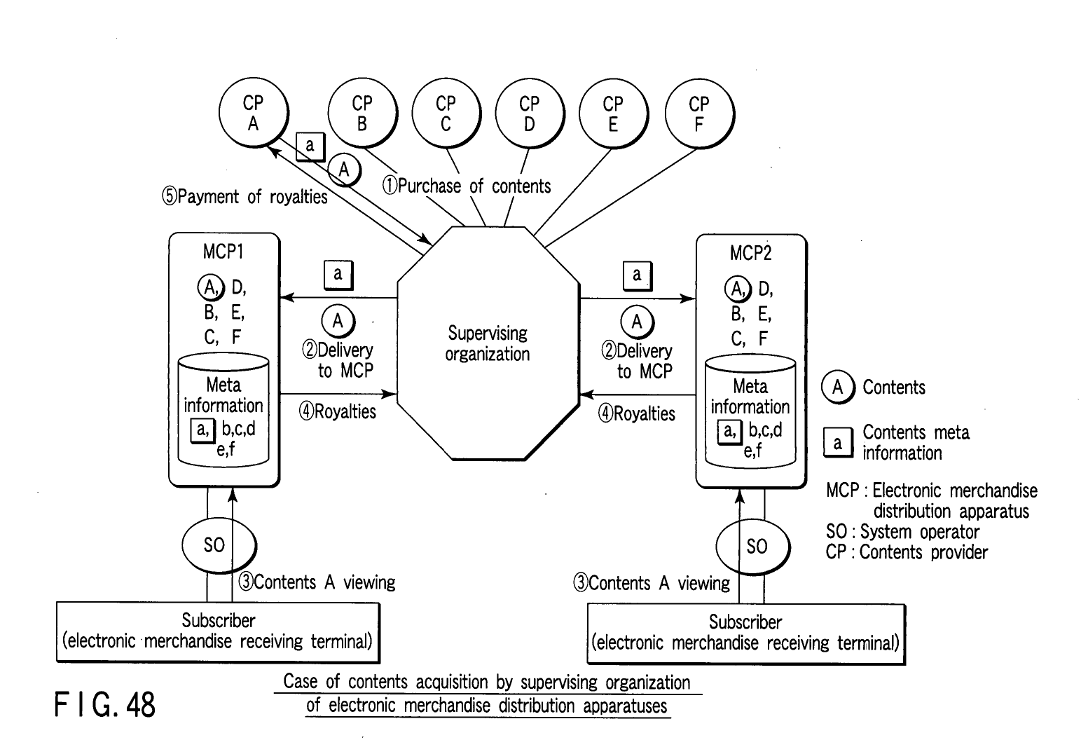

The contents acquisition flow by supervising organization of electronic merchandise distribution apparatuses will be shown in FIG. 48.

(1) The supervising organization of electronic merchandise distribution apparatuses acquires contents A and contents meta information a from contents provider A.

(2) The supervising organization of electronic merchandise distribution apparatuses registers and distributes contents A and contents meta information a in all electronic merchandise distribution apparatuses.

(3) The subscriber views contents A, the system operator collects contents usage fee from the subscriber, and pays a part to the electronic merchandise distribution apparatus.

(4) The electronic merchandise distribution apparatus pays part of the contents usage fee collected from the system operator to the supervising organization of electronic merchandise distribution apparatuses as royalty to the contents provider.

(5) The supervising organization of electronic merchandise distribution apparatuses sums up the royalties collected from all electronic merchandise distribution apparatuses, and pays to the contents provider.

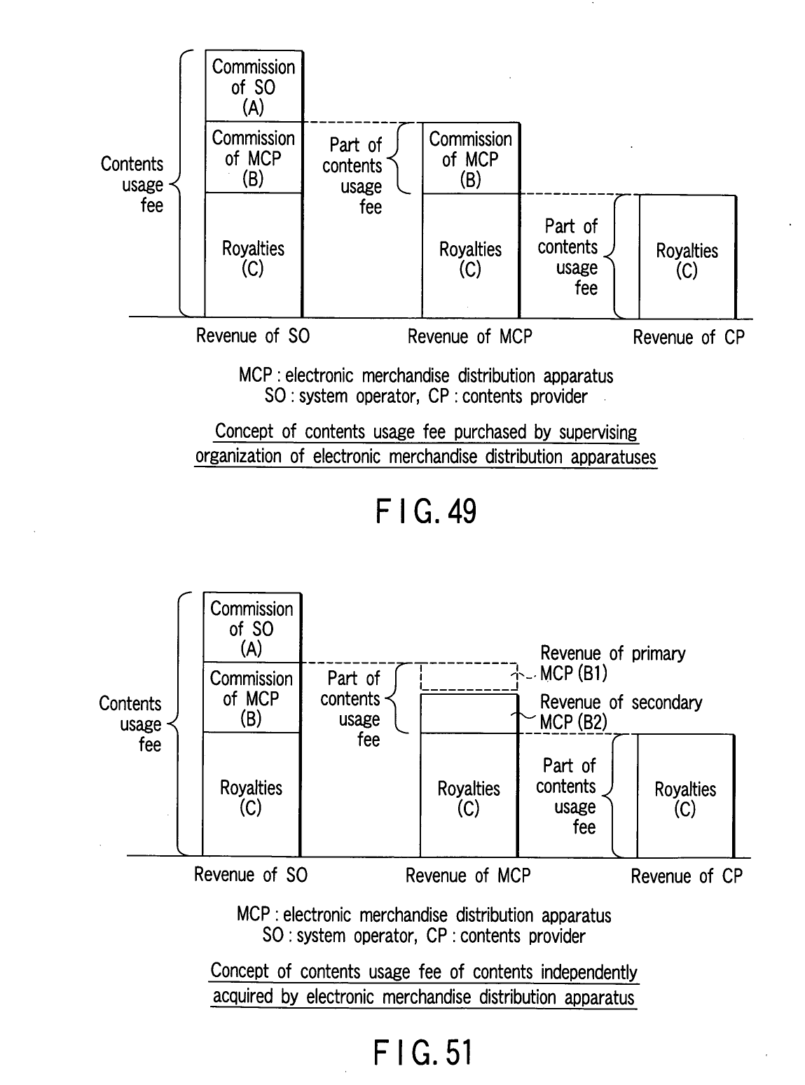

The concept of the contents usage fee is shown in FIG. 49.

The contents usage fee paid by the viewer includes the following:

Contents usage fee=commission of system operator(A)+commission of electronic merchandise distribution apparatus(B)+royalty of contents provider(C)

In this case, the electronic merchandise distribution apparatus presenting the contents to the system operator gains the commission of electronic merchandise distribution apparatus (B), and the royalties of the contents provider are summed up by the supervising organization of electronic merchandise distribution apparatuses from all electronic merchandise distribution apparatuses, and paid to the contents provider.

(Case of Acquiring Contents Independently by Electronic Merchandise Distribution Apparatus)

When a certain electronic merchandise distribution apparatus negotiates contents acquisition independently with the contents provider, the electronic merchandise distribution apparatus can utilize the subscribers of all electronic merchandise distribution apparatuses as latent users. Contents acquired by the electronic merchandise distribution apparatus can be used in other electronic merchandise distribution apparatuses in order to increase the quantity of contents.

At this time, in order to give incentives to the electronic merchandise distribution apparatus 1 successfully negotiating with the contents provider, the electronic merchandise distribution apparatus gaining the contents (primary electronic merchandise distribution apparatus) can receive a certain portion of commission of each electronic merchandise distribution apparatus as royalties, concerning the contents usage fee, when the same contents are used by other electronic merchandise distribution apparatuses (secondary electronic merchandise distribution apparatuses) using the acquired contents.

When the electronic merchandise distribution apparatus is allowed to acquire the contents independently, if three or more electronic merchandise distribution apparatuses act independently, there arises a problem of connection state among the electronic merchandise distribution apparatuses. Basically, the electronic merchandise distribution apparatuses are mutually connected, but they can be also connected in a tree structure.

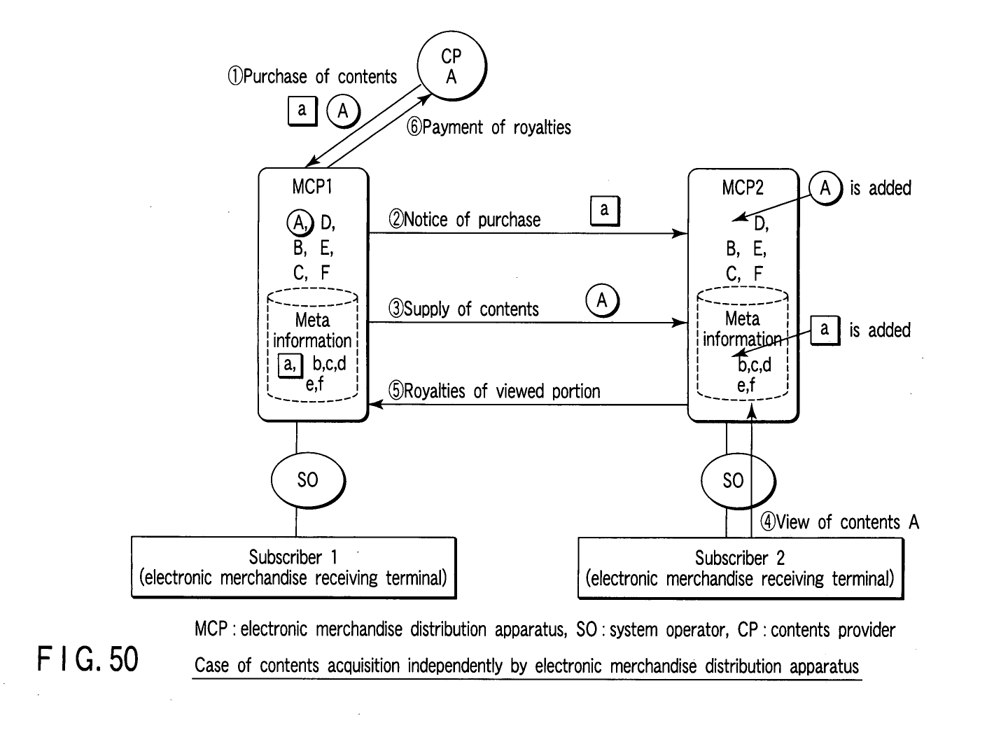

When the electronic merchandise distribution apparatuses acquire contents independently, the flow is as shown in FIG. 50.

(1) A certain electronic merchandise distribution apparatus (primary electronic merchandise distribution apparatus) acquires new contents A and contents meta information a from contents provider A.

(2) The primary electronic merchandise distribution apparatus notices acquisition of contents A to other electronic merchandise distribution apparatuses (secondary electronic merchandise distribution apparatuses) by sending contents meta information a.

(3) The primary electronic merchandise distribution apparatus sends contents A to secondary electronic merchandise distribution apparatuses.

(4) Subscribers connected to secondary electronic merchandise distribution apparatuses view contents A through the electronic merchandise guide, the system operator collects contents usage fee from the subscribers, and pays a part to the secondary electronic merchandise distribution apparatuses.

(5) The secondary electronic merchandise distribution apparatuses recognize the contents are acquired by other electronic merchandise distribution apparatus, that is, recognize the presence of the primary electronic merchandise distribution apparatus (contents meta information is used for this recognition), and subtract the commission of the secondary electronic merchandise distribution apparatuses from the commission of the electronic merchandise distribution apparatus, and remit the remainder to the primary electronic merchandise distribution apparatus.

(6) The primary electronic merchandise distribution apparatus subtracts the own commission of the primary electronic merchandise distribution apparatus, and sums up the remaining royalties for the contents provider, and pays to the contents provider.

In this case, the contents provider A and the primary electronic merchandise distribution apparatus contract, but the contract may be made by the supervising organization of electronic merchandise distribution apparatuses, and the contents are acquired and royalties are paid via the supervising organization of electronic merchandise distribution apparatuses.

(Concept of Contents Usage Fee)

As shown in FIG. 51, the contents usage fee of the contents acquired independently by the electronic merchandise distribution apparatus includes the following:

Contents usage fee=commission of system operator(A)+commission of primary electronic merchandise distribution apparatus(B1)+commission of secondary electronic merchandise distribution apparatus(B2)+royalty of contents provider(C)

In this case, the primary electronic merchandise distribution apparatus is the electronic merchandise distribution apparatus acquiring the contents. When subscribers of the system operator having service presented to the primary electronic merchandise distribution apparatus (electronic merchandise distribution apparatus 1 in this example) view the contents, both the revenue of the primary electronic merchandise distribution apparatus and revenue of the secondary electronic merchandise distribution apparatuses are revenues of the electronic merchandise distribution apparatus 1.

Thus, according to the embodiment, conventional problems such as problem of spending of band by CODEC, problem of distribution technology, problem of lack of excellent contents in VOD service, and problem of a method of presenting electronic merchandise can be solved, and the electronic merchandise including video can be effectively provided to the end users.

As described herein, the invention can effectively provide electronic merchandise including video to end users.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic merchandise distribution apparatus applied to a system including a plurality of terminals capable of receiving electronic program guide (EPG) and contents, and a plurality of access providers disposed between the electronic merchandise distribution apparatus and at least part of the plurality of terminals and capable of transmitting the EPG and contents to be distributed from the electronic merchandise distribution apparatus to the part of the plurality of the terminals which make contents viewing requests, the apparatus comprising:
an information management unit which acquires at least one of viewing information, preference information, and retrieval information of a user who uses one of the plurality of terminals; and
a distribution management unit which stores non-real-time contents compressed by a CODEC, in an access provider corresponding to one of the plurality of terminals used by the user, based on the acquired at least one of the viewing information, preference information, and retrieval information of the user, prior to receiving the contents viewing request from the user.

2. The electronic merchandise distribution apparatus according to claim 1, wherein each of the plurality of access providers includes:
a first distribution server capable of storing the contents sent from the electronic merchandise distribution apparatus and distributing the stored contents, and
a plurality of second distribution servers capable of storing the contents sent from the first distribution server and distributing the stored contents to one of the plurality of terminals used by the user when receiving the contents viewing request from the user.

3. The electronic merchandise distribution apparatus according to claim 1, wherein:
the information management unit includes a viewing information collection and management unit which collects and manages viewing information of contents viewed by viewers at each terminal, and
the distribution management unit distributes EPG or contents on which the viewing information is reflected.

4. The electronic merchandise distribution apparatus according to claim 1, wherein:
the information management unit includes a preference information management unit which acquires and manages preference information of contents favored by viewers at each terminal, and
the distribution management unit distributes EPG or contents on which the preference information is reflected.

5. The electronic merchandise distribution apparatus according to claim 1, further comprising an electronic merchandise guide unit which generates and distributes a screen displaying electronic merchandise guide information capable of being customized at each terminal.

6. The electronic merchandise distribution apparatus according to claim 5, wherein the electronic merchandise guide unit is capable of generating and distributing a screen on which contents obtained from a public network are reflected.

7. The electronic merchandise distribution apparatus according to claim 3, further comprising a retrieval unit which provides a contents retrieval result on which the viewing information depending on a contents retrieval request from a terminal is reflected.

8. The electronic merchandise distribution apparatus according to claim 4, further comprising a retrieval unit which provides a contents retrieval result on which the preference information depending on a contents retrieval request from a terminal is reflected.

9. An electronic merchandise receiving terminal capable of receiving electronic program guide (EPG) and contents distributed from an electronic merchandise distribution apparatus by way of an access provider, the terminal comprising:
a first processing unit which requests contents viewing to the access provider; and
a second processing unit which receives contents stored in the access provider by the electronic merchandise distribution apparatus prior to the contents viewing request, from the access provider when requesting the contents viewing.

10. An electronic merchandise distribution method applied to a system including a plurality of terminals capable of receiving electronic program guide (EPG) and contents, an electronic merchandise distribution apparatus capable of distributing the EPG and contents, and a plurality of access providers disposed between the electronic merchandise distribution apparatus and at least part of the plurality of terminals, and capable of transmitting the EPG and contents distributed from the electronic merchandise distribution apparatus to the part of the plurality of terminals which make contents viewing requests, the method comprising:
acquiring, by the merchandise distribution apparatus, at least one of viewing information, preference information, and retrieval information of a user who uses one of the plurality of terminals; and
storing, by the merchandise distribution apparatus, non-real-time contents compressed by a CODEC, in an access provider corresponding to one of the terminals used by the user, based on the acquired at least one of the viewing information, preference information, and retrieval information of the user, prior to receiving the contents viewing request from the user.

11. The electronic merchandise distribution method according to claim 10, further comprising:
storing the contents sent from the electronic merchandise distribution apparatus in a first distribution server in each of the plurality of access providers and distributing the stored contents, and
storing the contents sent from the first distribution server in a plurality of second distribution servers in each of the plurality of access providers and distributing the stored contents to one of the plurality of terminals used by the user when receiving the contents viewing request from the user.

12. The electronic merchandise distribution method according to claim 10, further comprising:
collecting and managing, by the electronic merchandise distribution apparatus, viewing information of contents viewed by viewers at each terminal to distribute EPG or contents on which the viewing information is reflected.

13. The electronic merchandise distribution method according to claim 10, further comprising:
acquiring and managing, by the electronic merchandise distribution apparatus, preference information of contents favored by viewers at each terminal to distribute EPG or contents on which the preference information is reflected.

14. The electronic merchandise distribution method according to claim 10, further comprising:
generating and distributing, by the electronic merchandise distribution apparatus, a screen displaying electronic merchandise guide information capable of being customized at each terminal.

15. The electronic merchandise distribution method according to claim 14, further comprising:
generating and distributing, by the electronic merchandise distribution apparatus, a screen on which contents obtained from a public network are reflected.

16. The electronic merchandise distribution method according to claim 12, further comprising:
providing, by the electronic merchandise distribution apparatus, a contents retrieval result on which the viewing information depending on a contents retrieval request from a terminal is reflected.

17. The electronic merchandise distribution method according to claim 13, further comprising:
providing, by the electronic merchandise distribution apparatus, a contents retrieval result on which the preference information depending on a contents retrieval request from a terminal is reflected.

18. An electronic merchandise distribution method applied to a system which allows a supervising organization to distribute contents purchased from a contents provider to each of a plurality of electronic merchandise distribution apparatuses, and each electronic merchandise distribution apparatus to distribute the contents received from the supervising organization to electronic merchandise receiving terminals through a corresponding system operator, the method comprising:
deducting, by the system operator, own commission of the system operator from a contents usage fee collected from the electronic merchandise receiving terminals, and paying the remainder to a corresponding electronic merchandise distribution apparatus;
deducting, by the electronic merchandise distribution apparatus, own commission of the electronic merchandise distribution apparatus from an amount paid from the system operator, and paying a remainder to the supervising organization; and
paying, by the supervising organization, an amount obtained from the electronic merchandise distribution apparatus to the contents provider as a royalty.

19. An electronic merchandise distribution method applied to a system which allows a first electronic merchandise distribution apparatus to distribute contents purchased from a contents provider to a second electronic merchandise distribution apparatus, and the second electronic merchandise distribution apparatus to distribute the contents received from the first electronic merchandise distribution apparatus to electronic merchandise receiving terminals through a system operator, the method comprising:
deducting, by the system operator, own commission of the system operator from a contents usage fee collected from the electronic merchandise receiving terminals, and paying a remainder to the second electronic merchandise distribution apparatus;
deducting, by the second electronic merchandise distribution apparatus, own commission of the second electronic merchandise distribution apparatus from an amount paid from the system operator, and paying a remainder to the first electronic merchandise distribution apparatus; and
deducting, by the first electronic merchandise distribution apparatus, own commission of the first electronic merchandise distribution apparatus from an amount paid from the second electronic merchandise distribution apparatus, and paying a remainder to the contents provider as a royalty.
